(19) United States
(12) Patent Application Publication
(10) Pub. No.: US 2015/0095410 A1
(43) Pub. Date: Apr. 2, 2015

(54) SERVER SYSTEM, SERVER DEVICE, STORAGE MEDIUM STORING INFORMATION PROCESSING PROGRAM, AND INFORMATION PROCESSING METHOD FOR SERVER SYSTEM

(71) Applicant: NINTENDO CO., LTD., Kyoto-shi (JP)

(72) Inventors: Kiyofumi Funahashi, Kyoto (JP); Kota Chikamatsu, Kyoto (JP)

(21) Appl. No.: 14/479,702

(22) Filed: Sep. 8, 2014

(30) Foreign Application Priority Data
Oct. 2, 2013 (JP) 2013-207379

(51) Int. Cl. H04L 29/08; H04L 29/06

(52) U.S. Cl. CPC H04L 67/2857; H04L 67/42
USPC 709/203

(57) ABSTRACT

An example server provides a service by which predetermined information regarding a certain user is made viewable by another user. The server receives, from a terminal device of a first user, a request for registering the first user as a registered user with a second user. The server identifies another user separate from the second user as an approver who has an authority to approve the request made to the second user. The server transmits an inquiry about approval of the request to a terminal device of the approver, receives an answer for the inquiry from the terminal device of the approver, and determines whether or not to approve the request based on the received answer. If it is determined that the request is approved, the server stores, in a storage device, identification information of the first user as a registered user with the second user.

### CROSS REFERENCE TO RELATED APPLICATIONS

The disclosure of Japanese Patent Application No. 2013-207379, filed on Oct. 2, 2013, is herein incorporated by reference.

### FIELD

The present technique relates to a server system, a server device, a storage medium storing an information processing program, and an information processing method for server systems for providing a service of allowing saved information of a user to be viewed by other users.

### BACKGROUND AND SUMMARY

Conventionally, so-called “SNS's (social networking services)” allow a user to save the user's own information (a profile, journals, pictures, etc.) on a server so that other users can view the information. Part of the saved information may be restricted from being viewed so that it can be viewed only by other users who have been registered as friends. A user can make a friend request to another user, and if the other user approves the request, the requesting user is registered as a friend of the approving user. Then, the requesting user can view more information regarding the approving user.

In SNS's and other similar services, when a user receives a friend request from another user who the user does not know in the real world, it may be difficult for the user to decide if the user should approve the request.

Therefore, the present request discloses a server system, a server device, a storage medium storing an information processing program, and an information processing method for server systems with which it is possible to reduce the burden on a user of deciding whether or not to approve a request from another user.

(1)

An example server system described herein is a server system for saving information regarding a plurality of users and providing predetermined information regarding a certain user to another user. The server system includes a registration storing unit, a request receiving unit, an approver identification unit, a first inquiry unit, and an approval determination unit.

The registration storing unit stores in a storage section, for each user, identification information of another user registered as a registered user who is granted a predetermined authority over information regarding the user. The request receiving unit receives, from a terminal device of a first user, a request for registering the first user as a registered user with a second user. The approver identification unit identifies another user separate from the second user as an approver who has an authority to approve the request made to the second user. The first inquiry unit transmits an inquiry about approval of the request to a terminal device of the approver, and receives an answer for the inquiry from the terminal device of the approver. The approval determination unit determines whether or not to approve the request by the first user based on the received answer.

If it is determined by the approval determination unit that the request by the first user is approved, the registration storing unit stores, in the storage section, identification information of the first user as a registered user with the second user.

With configuration (1) above, the second user can ask the approver to approve/disapprove the request made to himself/herself, and it is therefore possible to reduce the burden on the second user of deciding whether or not to approve the request.

(2)

The server system may further include an approver storage unit for storing in the storage section, for at least one user, information of an approver who has an authority to approve a request made to the user, prior to the request. The approver identification unit may identify an approver based on the information of the approver stored in the storage section.

With configuration (2) above, the second user does not need to select an approver each time a request is made, thereby facilitating the setting of an approver.

(3)

The server system may further include a second inquiry unit for transmitting an inquiry about approval of the request to a terminal device of the second user, and receiving an answer for the inquiry from the terminal device of the second user. The approval determination unit may make the determination based on the answer from the approver and the answer from the second user.

With configuration (3) above, since the second user himself/herself can determine whether or not to approve while whether or not to approve is determined based also on the approval by the approver, it is possible to reduce the decision burden on the second user.

(4)

If the answer received by the second inquiry unit indicates approval of the request, the first inquiry unit may transmit the inquiry about approval of the request to the terminal device of the approver, whereas if the answer indicates disapproval of the request, the first inquiry unit may not transmit the inquiry to the terminal device of the approver. The approval determination unit may determine to approve the request by the first user if the answer from the second user and the answer from the approver both indicate approval of the request.

With configuration (4) above, since no inquiry will be sent to the approver if the second user does not approve, the approver does not need to give an answer if there is no need to do so. Thus, it is possible to reduce the operation burden on the approver.

(5)

The server system may further include a notification unit for, if the answer received by the first inquiry unit indicates approval of the request, notifying the terminal device of the second user that the request has been made from the first user to the second user.

With configuration (5) above, since requests that are not approved by the approver will not be notified to the second user, it is possible to save the second user's time and trouble for checking.

(6)

The server system may further include a notification unit for, before the first inquiry unit transmits the inquiry to the terminal device of the approver, notifying the terminal device of the second user that the request has been made from the first user to the second user.

With configuration (6) above, even though the approval is done by the approver, the second user can be notified in advance that a request has been made.

(7)

The server system may further include an approver determination unit for receiving, from the terminal device of the second user, information regarding whether or not to set the approver, and determining whether or not to set the approver based on the received information. The approver identification unit may identify the approver if it is determined that the approver is to be set.

With configuration (7) above, since the second user is allowed to choose whether or not to set an approver, the second user can himself/herself make a decision on the approval of a request or can ask another party to approve/disapprove. Thus, it is possible to reduce the burden on the second user of the approval decision, and it is also possible to easily register the first user as a registered user (if it is decided that there is no need to ask for approval/disapproval).

(8)

The server system may further include an approver inquiry unit for, if the request is received by the request receiving unit, transmitting an inquiry for selecting an approver for the request to the terminal device of the second user, and receiving information indicating a selected approver from the terminal device of the second user. The approver identification unit may identify the approver based on the received information indicating the approver.

With configuration (8) above, since the second user can set an approver for each request, it is possible to select an appropriate approver depending on the request.

(9)

The server system may further includes an allower identification unit, an allowance inquiry unit, and a request determination unit. If the request is received by the request receiving unit, the allower identification unit identifies another user separate from the first user as a request allower who has an authority to allow the first user to make a request. If the request is received by the request receiving unit, the allowance inquiry unit transmits an inquiry about allowance of the request to a terminal of the request allower, and receives an answer for the inquiry from the terminal device of the request allower. The request determination unit renders the request by the first user valid if the answer received by the allowance inquiry unit indicates allowance of the request, and renders the request by the first user invalid if the answer received by the allowance inquiry unit indicates non-allowance of the request. Then, if the request is rendered valid, the first inquiry unit may transmit the inquiry about approval of the request to the terminal device of the approver.

With configuration (9) above, another user as a request allower can restrict the first user from making a request. Thus, it is possible to prevent the first user from making a request to a user whose legitimacy is dubious.

(10)

The first inquiry unit may transmit, to the terminal device of the approver, information including link information for accessing a webpage for giving an answer for the inquiry about approval of the request, and obtain the answer made on the webpage by the terminal device of the approver.

With configuration (10) above, a person who has no account issued by the server system can be appointed an approver. An approver with no account does not need to perform a registration operation for obtaining an account, and it is therefore possible to save the approver's time and trouble.

(11)

The allowance inquiry unit may transmit, to the terminal device of the request allower, information including link information for accessing a webpage for giving an answer for the inquiry to the terminal device of the request allower, and obtain the answer made on the webpage by the terminal device of the request allower.

With configuration (11) above, a person who has no account issued by the server system can be appointed a request allower. A request allower with no account does not need to perform a registration operation for obtaining an account, and it is therefore possible to save the request allower's time and trouble.

(12)

If the inquiry about approval of the request is transmitted to the terminal device of the approver, the first inquiry unit may transmit, together with the inquiry, at least a part of profile information saved for the first user or link information for accessing the profile information.

With configuration (12) above, with reference to the information of the profile, it becomes easier for the approver to decide whether or not to approve.

(13)

If an answer for the inquiry about approval of the request is not received within a predetermined period since the issuance of the inquiry, the approval determination unit may consider it as being an answer for the inquiry indicating disapproval of the request by the first user.

With configuration (13) above, even if no answer is received from the approver, the server system can determine whether or not to approve the request.

(14)

Another example server system described herein is a server system for saving information regarding a plurality of users and providing predetermined information regarding a certain user to another user. The server system includes a registration storing unit, a request receiving unit, an evaluator identification unit, an evaluation inquiry unit, an approval inquiry unit, and an approval determination unit.

The registration storing unit stores in a storage section, for each user, identification information of another user registered as a registered user who is granted a predetermined authority over information regarding the user. The request receiving unit receives, from a terminal device of a first user, a request for registering the first user as a registered user with a second user. The evaluator identification unit identifies another user separate from the second user as an approver who has an authority to approve the request made to the second user. The evaluation inquiry unit transmits an inquiry about approval of the request to a terminal device of the approver, and receives an answer for the inquiry from the terminal device of the approver. The approval inquiry unit transmits evaluation information obtained based on the answer received by the evaluation inquiry unit and the inquiry about approval of the request to the terminal device of the second user, and receives an answer for the inquiry from the terminal device of the second user. The approval determination unit determines whether or not to approve the request by the first user based on the answer received by the approval inquiry unit. If it is determined that the request by the first user is approved, the registration storing unit stores, in the storage section, identification information of the first user as a registered user with the second user.

Note that in the above, the server system may transmit, simultaneously or separately, the evaluation information and the inquiry to the terminal device of the second user.

With configuration (14) above, the second user can ask the evaluator (evaluating user) to evaluate the request made to himself/herself, and it is therefore possible to decide whether or not to approve the request with reference to the evaluation by the evaluator. Thus, it is possible to reduce the burden on the second user of deciding whether or not to approve the request.

(15)

The server system may further include an evaluator storage unit for storing in the storage section, for at least one user, evaluator identification information of an evaluator who has an authority to evaluate a request made to the user, in advance prior to the request. The evaluator identification unit may identify the evaluator based on the identification information of the evaluator stored in the storage section.

With configuration (15) above, the second user does not need to select an evaluating user for each request, thereby facilitating the setting of an evaluating user.

(16)

The server system may further include an evaluator determination unit for receiving, from the terminal device of the second user, information regarding whether or not to set an evaluating user, and determining whether or not to set an evaluator based on the received information. The evaluator identification unit may identify an evaluator if it is determined that an evaluator is to be set.

With configuration (16) above, it is possible to reduce the burden on the second user of the approval decision, and it is also possible to easily register the first user as a registered user (if it is decided that there is no need to ask for evaluation).

(17)

The server system may further include an evaluator inquiry unit for, if a request is received by the request receiving unit, transmitting an inquiry for selecting an evaluator for the request to the terminal device of the second user, and receiving information indicating a selected evaluator from the terminal device of the second user. The evaluator identification unit may identify the evaluator based on the received information indicating the evaluator.

With configuration (17) above, since the second user can set an evaluating user for each request, it is possible to select an appropriate evaluating user depending on the first user who has made the request.

(18)

The server system may include an allower identification unit, an allowance inquiry unit, and a request determination unit. If the request is received by the request receiving unit, the allower identification unit identifies another user separate from the first user as a request allower who has an authority to allow the first user to make a request. If the request is received by the request receiving unit, the allowance inquiry unit transmits an inquiry about allowance of the request to a terminal of the request allower, and receives an answer for the inquiry from the terminal device of the request allower. The request determination unit renders the request by the first user valid if the answer received by the allowance inquiry unit indicates allowance of the request, and renders the request by the first user invalid if the answer received by the allowance inquiry unit indicates non-allowance of the request. Then, if the request is rendered valid, the evaluation inquiry unit may transmit the inquiry about approval of the request to the terminal device of the evaluator.

With configuration (18) above, another user as a request allower can restrict the first user from making a request. Thus, it is possible to prevent the first user from making a request to a user whose legitimacy is dubious.

(19)

If the inquiry about evaluation of the first user who has made the request is transmitted to the terminal device of the evaluating user, the evaluation inquiry unit may transmit, together with the inquiry, at least a part of profile information saved for the first user or link information for accessing the profile information.

With configuration (19) above, with reference to the information of the profile, it becomes easier for the evaluating user to make the evaluation.

(20)

The evaluation user identification unit may identify a plurality of evaluators. The evaluation inquiry unit may transmit an inquiry to each of the terminal devices of the identified evaluators, and receive an answer from each of the terminal devices. The approval inquiry unit may calculate a parameter indicating an index of evaluation from the received answers, and transmit the calculated parameter and the inquiry about approval of the request to the terminal device of the second user.

With configuration (20) above, where a plurality of evaluating users are set, it is possible to present the evaluation results to the second user in an easy-to-understand manner. Thus, it becomes easier for the second user to decide whether or not to approve.

(21)

The predetermined authority over information regarding the second user may be an authority to view information regarding the second user which cannot be viewed by another user who is not a registered user.

With configuration (21) above, in a server system providing an SNS allowing a registered user to view information that cannot be viewed by another use who is not a registered user, it is possible to reduce the burden on the user of deciding whether or not to approve the request.

Note that the present specification discloses an example information processing system including server systems of (1) to (21) above, and discloses an example non-transitory computer-readable storage medium storing an information processing program for causing a computer of an information processing device to function as units equivalent to those in the server systems of (1) to (21) above. The present specification also discloses an information processing method (user registration method) carried out by the server systems of (1) to (21) above.

With the server system, the server device, the storage medium storing an information processing program, and the information processing method for server systems described above, it is possible to reduce the burden on the user of deciding whether or not to approve the request from another user.

These and other objects, features, aspects and advantages will become more apparent from the following detailed description when taken in conjunction with the accompanying drawings.

### BRIEF DESCRIPTION OF THE DRAWINGS

FIG. 1 is a block diagram showing a configuration of a non-limiting example of an information processing system;

FIG. 2 is a diagram showing a non-limiting example of user information;

FIG. 3 is a diagram generally showing a non-limiting example of a flow of an operation when performing a friend registration;

FIG. 4 is a timing diagram showing a non-limiting example of a flow of a friend registration process in a first embodiment;

FIG. 5 is a diagram showing a non-limiting example of an inquiry screen displayed on a requested terminal 3b;

FIG. 6 is a flow chart showing a non-limiting example of a flow of an information process performed by a server 2 (a control section 12) in the first embodiment;

FIG. 7 is a timing diagram showing a non-limiting example of a flow of a friend registration process in a second embodiment;

FIG. 8 is a diagram showing a non-limiting example of an answer screen to be shown on the requested terminal 3b upon receiving a request notification;

FIG. 9 is a flow chart showing a non-limiting example of a flow of an information process performed by the server 2 (the control section 12) in the second embodiment;

FIG. 10 is a diagram generally showing a non-limiting example of a flow of an operation when a friend registration is performed in a third embodiment;

FIG. 11 is a timing diagram showing a non-limiting example of a flow of a friend registration process in the third embodiment;

FIG. 12 is a diagram showing a non-limiting example of an inquiry screen in the third embodiment;

FIG. 13 is a flow chart showing a non-limiting example of a flow of an information process performed by the server 2 (the control section 12) in the third embodiment;

FIG. 14 is a diagram generally showing a non-limiting example of a flow of an operation when a friend request is made in a variation of the first embodiment; and

FIG. 15 is a timing diagram showing a non-limiting example of a flow of a friend request process in the variation shown in FIG. 14.

### DETAILED DESCRIPTION OF NON-LIMITING EXAMPLE EMBODIMENTS

Some embodiments and variations will now be described as examples of a server system (server device), an information processing system, a storage medium storing an information processing program, and an information processing method of the present embodiment.

### First Embodiment

### 1. Configuration of Information Processing System of First Embodiment

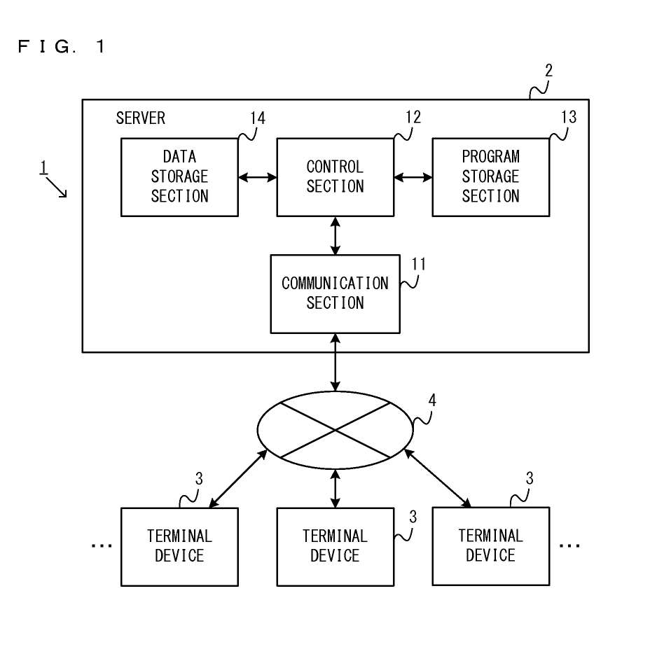

A server system, an information processing system, an information processing program, and an information processing method carried out by a server system according to the first embodiment will now be described. FIG. 1 is a block diagram showing a configuration of an example of an information processing system according to the first embodiment. As shown in FIG. 1, an information processing system 1 includes a server (server system) 2, a plurality of terminal devices 3, and a network 4. The server 2 can communicate with the terminal devices 3 via the network 4.

In FIG. 1, the server 2 is a server providing an SNS. That is, the server 2 provides a website of the SNS for terminal devices 3 accessing the server 2. While the SNS provided by the server 2 may be of any content, the server 2 in the present embodiment saves information (a profile, journals, pictures, etc.) regarding a user of the SNS, and provides the saved information so that the information can be viewed by other users. Note that the SNS's function is not limited to allowing other users to view information, but the SNS may also provide other functions such as, for example, exchanging messages between users, and posting messages on a bulletin board available between specific users.

The server 2 includes one or more information processing device (server device). The term “server” as used herein refers to one information processing device (server device), and may also refer to a group of server devices (server system) as a whole in cases where the server is composed of a plurality of server devices.

The terminal device 3 is an example of an information processing device to be operated by a user using the SNS provided by the server 2. The terminal device 3 may be an information processing device of any form capable of communicating with the server 2 via the network 4, e.g., a personal computer, a mobile terminal, a smartphone, a game device, etc. Note that while the network 4 is the Internet, for example, the network 4 may be any other network.

The server 2 includes a control section 12 for performing various information processes. The server 2 also includes a program storage section 13 storing an information processing program to be executed on the server 2. The control section 12 has a CPU (Central Processing Unit) and a memory, and the various information processes are performed by the CPU executing the information processing program using the memory. The server 2 also includes a communication section 11 for exchanging data with the terminal devices 3 via the network 4. The communication section 11 exchanges data with the terminal devices 3 in response to instructions from the control section 12 at appropriate points in time depending on the information processes being performed.

The server 2 also includes a data storage section 14 storing various data for providing the SNS. Note that the storage sections 13 and 14 may each be any storage device (storage medium) provided in the server 2. The data storage section 14 stores, as one of the various data, information (user information) regarding a user of the SNS.

FIG. 2 is a diagram showing an example of the user information. Note that FIG. 2 shows information stored (saved) for one user. That is, user information 21 shown in FIG. 2 is stored in the data storage section 14 for each user of the SNS.

As shown in FIG. 2, the user information 21 includes identification information 22. The identification information 22 is, for example, the ID, the name, or the like, of the user (the account assigned to the user). The identification information 22 may include a password used by the user to log in to the website of the SNS.

The user information 21 also includes viewable information 23 for being viewed on the website of the SNS. In the present embodiment, a user can register other users as friends, and predetermined information of the viewable information of the user can be viewed by other users registered as friends but cannot be viewed by other users not registered as friends. That is, a user registered as a friend is a user who is granted an authority to view the predetermined information.

Specifically, the viewable information 23 includes restricted information 24 and non-restricted information 25 (that is, the viewable information 23 can be divided into the restricted information 24 and the non-restricted information 25). The restricted information 24 is information that can be viewed only by users registered as friends (cannot be viewed by users not registered as friends). The non-restricted information 25 is information that can be viewed by any users (whether registered as friends or not). For example, basic profile information including the name, the hobbies, etc., may be saved as the non-restricted information 25, and information that the user does not wish to be viewed by all users, such as journals and family pictures, etc., may be saved as the restricted information 24.

Note that the user may be allowed to individually determine whether each information included in the viewable information is set as the restricted information 24 or as the non-restricted information 25. Alternatively, whether each type (item) of information is set as the restricted information 24 or as the non-restricted information 25 may be set in advance (e.g., the name of the user is set as the non-restricted information 25).

The user information 21 includes friend information 26. The friend information 26 represents identification information of other users who are registered as friends with the user associated with the user information 21. That is, the other users represented by the friend information 26 can view the restricted information 24. In the present embodiment, a user can make a friend request to another user, and if the request is approved, the requesting user is registered as a friend with the other user, the details of which will be described later.

The user information 21 includes approver information 27. In the present embodiment, when a user receives a friend request from a certain user, the user can ask another user (e.g. a guardian or a friend) to approve/disapprove (i.e., have another user approve/disapprove on behalf of the user), the details of which will be described later. The approver information 27 represents identification information of another user (referred to as the “approving user”) who has an authority to approve a friend request to the user. The approver information 27 is set when the user asks another user to approve/disapprove. That is, where the approver information 27 is set in the user information 21, a friend request to the user associated with the user information 21 is approved by the approving user represented by the approver information 27 (the details of which will be described later).

The user information 21 includes notification information 28. The notification information 28 represents the presence/absence of a notification (including an inquiry, or the like) from the server 2 to the user, and if there is a notification, the notification information 28 includes information that is to be transmitted for the notification (referred to as the “transmit information”). When there is a friend request to a certain user, for example, the server 2 stores, as the notification information 28 of the user information 21 of the certain user, information representing a notification that there has been a friend request and transmit information (e.g., the profile information of a user who has made the friend request, etc.) to be transmitted to the terminal device 3 of the certain user upon notification, the details of which will be described later. Note that the notification and the transmit information are transmitted to the terminal device 3 of the certain user when the terminal device 3 next logs in to the website of the SNS by accessing the server 2.

### 2. Outline of Process Performed by Information Processing System

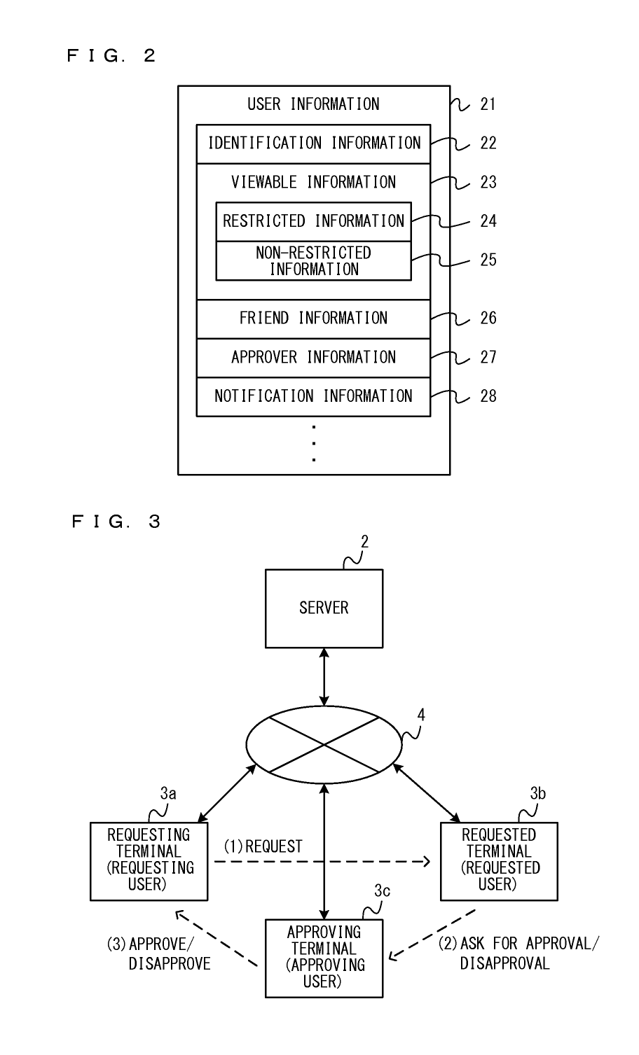

Referring now to FIGS. 3 to 5, an outline of a friend registration process to be performed by the information processing system 1 of the first embodiment will be described. FIG. 3 is a diagram generally showing a flow of an operation when a friend registration is performed. A process performed by the information processing system 1 will now be described, where a certain user (referred to as the “requesting user”) makes a friend request to another user (referred to as the “requested user”) ((1) shown in FIG. 3), the requested user asks the approving user to approve/disapprove ((2) shown in FIG. 3), and the approving user approves/disapproves ((3) shown in FIG. 3), as shown in FIG. 3.

Note that it is assumed in the first embodiment that the approving user is determined in advance for the requested user, and that the user information 21 of the requested user stored in the server 2 includes the approver information 27 representing the approving user. Note that one possible example is where the requested user is a child, and a parent (guardian) of the child is registered in advance as the approving user. That is, the first embodiment can be used under circumstances where there is a friend request from a stranger to a child, a parent of the child approves/disapproves the request.

In the description below, a requesting terminal 3a refers to a terminal device 3 used by the requesting user for using the SNS, a requested terminal 3b refers to a terminal device 3 used by the requested user for using the SNS, and an approving terminal 3c refers to a terminal device 3 used by the approving user for using the SNS. Although it is assumed in the first embodiment that the terminals 3a to 3c are separate terminal devices from each other, a user can use any terminal device for accessing the server 2. For example, a single terminal device may be used as the requested terminal 3b and as the approving terminal 3c.

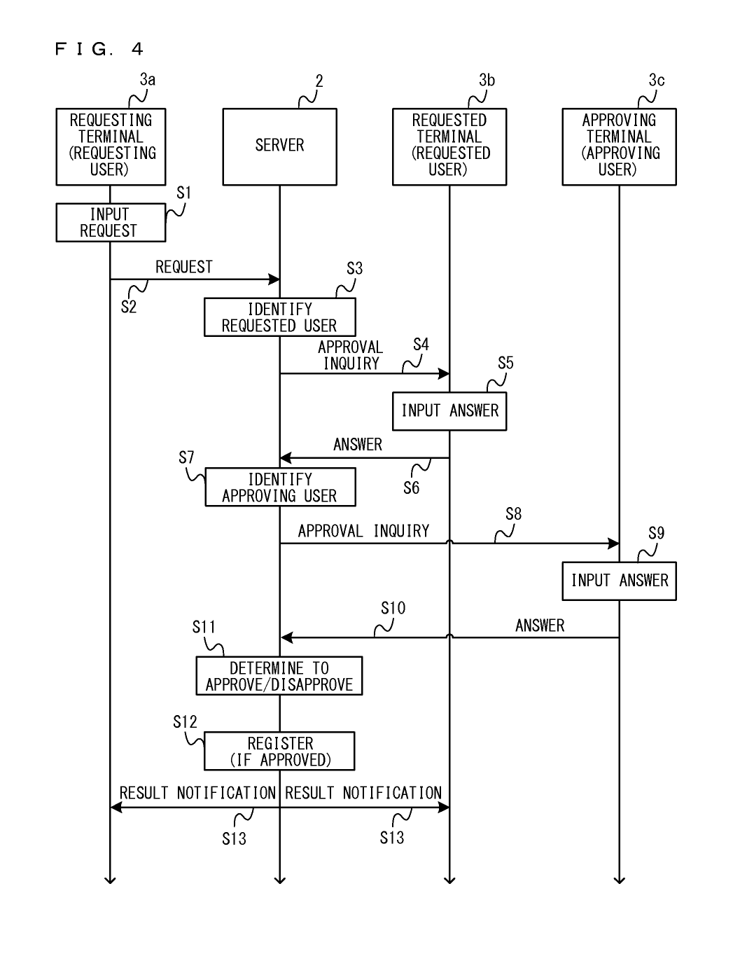

FIG. 4 is a timing diagram showing a flow of a friend registration process in the first embodiment. First, the requesting user inputs a friend request on the SNS using the requesting terminal 3a (step S1). That is, the requesting terminal 3a displays, on the display device, a webpage for making a friend request in the website of the SNS, and accepts an input from the requesting user to make a friend request. The requesting user inputs information (the name, the identification information, etc.) with which it is possible to identify the requested user. In this process, a message to the requested user may be input. The server 2 may perform a user search based on a search condition input by the requesting user to present the search results on the requesting terminal 3a. Then, the requesting user may select the requested user from among users presented as search results.

After information to make a friend request is input, the requesting terminal 3a issues a friend request to the server 2, and the server 2 accepts the friend request (step S2). Specifically, the requesting terminal 3a transmits, to the server 2, request information including the information input for the friend request and the identification information of the requesting user.

When the request information from the requesting terminal 3a is received, the server 2 identifies the requested user, to whom the friend request is being made (step S3). That is, the server 2 identifies the requested user based on the above-mentioned information included in the request information with which it is possible to identify the requested user.

In the first embodiment, when there is a friend request, the server 2 first issues an inquiry to the requested user whether or not to approve the friend request. Then, if the requested user answers that the requested user does not approve the friend request, the server 2 decides that the friend request is not approved. On the other hand, if the requested user answers that the requested user approves the friend request, the server 2 further issues an inquiry to the approving user of the requested user whether or not to approve the friend request. Note that when to transmit inquiries to the requested user and the approving user is arbitrary, and the server 2 may issue an inquiry to the approving user before the requested user. The server 2 may also issue inquiries simultaneously to the requested user and to the approving user.

Specifically, if the requested user is identified in step S3, the server 2 issues an inquiry about the friend request to the requested terminal 3b, which is the terminal of the requested user (step S4). This is an inquiry about whether or not the requested user approves the request.

Now, a notification (including an inquiry) from the server 2 to a user is made as follows. First, when a notification arises, the notification information 28 regarding the notification is stored in the server 2, after which the transmit information included in the notification information 28 is transmitted from the server 2 to the terminal device 3 in response to the terminal device 3 of the user using the SNS (having logged in to the SNS). That is, in step S4, the server 2 first stores information that indicates that a notification is to be made, and transmit information that is to be transmitted for an inquiry, as the notification information 28 of the user information 21 of the requested user. Then, when the requested user accesses the server 2 using the requested terminal 3b and logs in to the SNS, the server 2 determines the presence/absence of a notification (an inquiry) to the requested user with reference to the notification information 28 included in the user information 21 of the requested user. If it is determined that there is a notification, the server 2 transmits the transmit information included in the notification information 28 to the requested terminal 3b. Note that in an alternative embodiment, when there arises a notification from the server 2 to the terminal device 3, the server 2 may notify of the notification via email, or the like, (before the user logs in to the SNS).

In step S4, information for displaying an inquiry screen on the requested terminal 3b is transmitted as the transmit information. Specifically, this transmit information includes profile information including the name (account name) and a part of the viewable information of the requesting user. If an approving user has been set for the requested user, the transmit information includes the name (account name) of the approving user. If the transmit information from the server 2 is received by the requested terminal 3b, the requested terminal 3b displays the inquiry screen on the display device.

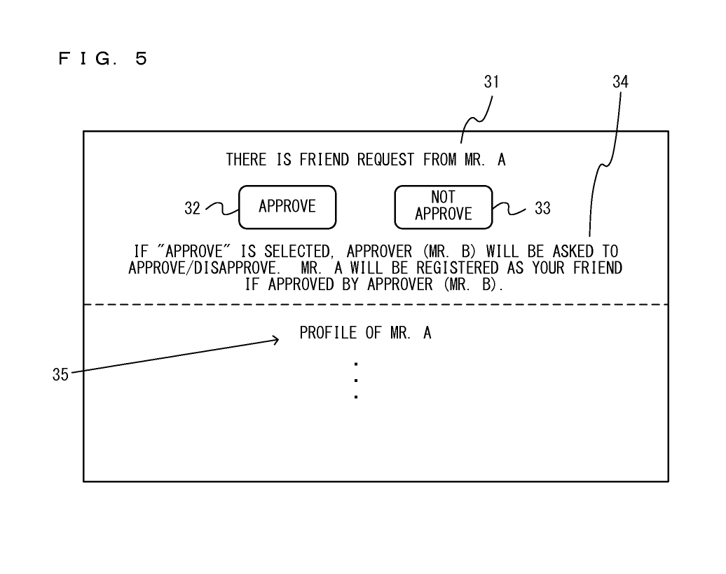

FIG. 5 is a diagram showing an example of an inquiry screen displayed on the requested terminal 3b. As shown in FIG. 5, the inquiry screen includes a message 31 indicating that there is a friend request from the requesting user, images (button images 32 and 33) used by the requested user to answer whether or not to approve the friend request, and a profile 35 of requesting user. In the present embodiment, the inquiry screen also includes a message 34 indicating that if the requested user answers to approve, the approving user will be asked to approve/disapprove.

Note that in an alternative embodiment, in step S4, the server 2 may identify users who are registered friends of the requesting user based on the user information 21 of the requesting user to transmit information (names, etc.) of the identified users to the requested terminal 3b. Then, information of users who are registered friends of the requesting user may be displayed on the requested terminal 3b instead of the profile (or in addition to the profile). The requested user can decide whether the requesting user is trustworthy by knowing the registered friends of the requesting user. For example, one may decide that the requesting user is trustworthy if the registered friends of the requesting user include one or more acquaintances (friends) of the requested user. Where even though the requesting user is an acquaintance of the requested user, the registered friends of the requesting user include no acquaintances (friends) of the requested user at all, one may suspect that the requesting user is someone else who is pretending to be the requesting user and may accordingly decide that the requesting user is untrustworthy.

When the inquiry screen is displayed on the requested terminal 3b, the requested user makes an input on the inquiry screen to input an answer whether or not to approve the friend request (step S5). For example, the requested user answers whether or not to approve by specifying, using an input device such as a touch panel or a mouse, the button image 32 for “APPROVE” or the button image 33 for “NOT APPROVE”. In response to the input, the requested terminal 3b transmits to the server 2 information representing the answer result (approval or disapproval) (step S6). The answer includes the identification information of the requested user, and the information of the answer result indicating approval or disapproval of the friend request.

The server 2 receives the answer of the requested user transmitted from the requested terminal 3b. If the received answer of the requested user indicates approval, the server 2 identifies the approving user of the requested user (step S7). The approving user can be identified with reference to the approver information 27 of the user information 21 of the requested user. Next, the server 2 issues an inquiry about the friend request to the approving terminal 3c, which is the terminal of the approving user (step S8). This is an inquiry about whether or not the approving user approves the request, as in the inquiry process in step S4. Specifically, as in step S4, the server 2 stores, included in the user information 21 of the approving user, the notification information 28 regarding the inquiry, and then the transmit information included in the notification information 28 is transmitted from the server 2 to the approving terminal 3c in response to the approving user using the SNS (having logged in to the SNS). Note that the content of the transmit information may be information for displaying an inquiry screen similar to the transmit information of step S4.

When the transmit information from the server 2 is received by the approving terminal 3c, the approving terminal 3c displays the inquiry screen on the display device, and accepts an answer input from the approving user. In this process, since the profile of the requesting user is displayed on the inquiry screen, the approving user can obtain information regarding the requesting user, and the approving user can make use of the information in deciding whether or not to approve. When the inquiry screen is displayed on the approving terminal 3c, the approving user inputs an answer indicating whether or not to approve the friend request by making an input on the inquiry screen (step S9). In response to the input, the approving terminal 3c transmits information representing the answer result (approval or disapproval) to the server 2 (step S10). The answer includes information of the answer result representing approval or disapproval of the friend request.

The server 2 receives the answer transmitted from the approving terminal 3c, and determines whether or not to approve the friend request based on the answer (step S11). In this process, if it is determined that the friend request is approved, the server 2 registers the requesting user as a friend of the requested user (step S12). Specifically, the friend information 26 in the user information 21 of the requesting user is updated so as to include the identification information of the requested user, and the friend information 26 in the user information 21 of the requested user is updated so as to include the identification information of the requesting user.

Moreover, the server 2 notifies the determination result to the requesting user and the requested user (step S13). This notification is also done using the notification information 28 as in the inquiry in steps S4 and S8. That is, the server 2 stores, included in the user information 21 of the requesting user and the requested user, the notification information 28 regarding the notification, and then the transmit information included in the notification information 28 is transmitted from the server 2 to the requesting terminal 3a or the requested terminal 3b in response to the requesting user or the requested user logging in to the SNS. Note that regarding the notification process of step S13, in an alternative embodiment, when it is determined in step S11 that the friend request is approved, the server 2 may give no notification to the requesting user (and the requested user).

As described above, in the present embodiment, when there is a friend request to the requested user, the server 2 identifies an approving user separate from the requested user as an approver who has an authority to approve the request made to the requested user (step S3). Then, the server 2 transmits an inquiry about approval of the request to the terminal device of the approving user (the approving terminal 3c), and receives an answer for the inquiry from the terminal device of the approving user (step S10). Moreover, the server 2 determines whether or not to approve the request from the requesting user based on the received answer (step S11) and, if it is determined that the request from the requesting user is approved, stores the identification information of the requesting user as a registered user (friend) with the requested user (step S12). Thus, the requested user can ask the approver (approving user) to approve/disapprove a friend request made to himself/herself, thereby reducing the burden on the requested user of deciding whether or not to approve the request.

If the user is a child, for example, the user may carelessly approve a friend request from a use who is a stranger or may fail to discover spoofing and approve a friend request from a stranger who is pretending to be an acquaintance of the requested user, which may result in some damage. In view of such cases, the server 2 allows a parent user to be registered as an approving user for a child user, for example, so that it is possible to prevent a fraudulent friend request from being approved by the child user and registered as a friend. Thus, the present embodiment can provide a parental control function in an SNS for a friend request to a child user.

In the first embodiment, the server 2 stores in the data storage section 14, for at least one user, the approver information 27 representing an approving user who has an authority to approve a friend request made to the user, in advance prior to the friend request (FIG. 2). Then, the server 2 identifies the approving user based on the approver information 27 stored in the data storage section 14 (when there is a friend request). Thus, the requested user does not need to select an approving user for each friend request, and can therefore easily set an approving user. Note that in an alternative embodiment, the requested user may set an approving user each time a friend request is made as in the second embodiment to be described below, for example.

In the first embodiment, the server 2 transmits an inquiry about approval of a friend request to the terminal device of the requested user (the requested terminal 3b), and receives an answer for the inquiry from the requested terminal 3b (step S6). Then, the server 2 makes a determination based on the answer from the approving user and the answer from the requested user. That is, it is determined that the friend request is approved if the approving user and the requested user both approve the request. Thus, since the requested user himself/herself can decide whether or not to approve while whether or not to approve is determined based also on the approval by the approving user, it is possible to reduce the decision burden on the requested user.

Note that in an alternative embodiment, the server 2 may issue an inquiry (whether or not to approve the friend request) (only) to the approving user without issuing the inquiry to the requested user. That is, the server 2 may perform steps S7 to S11 without performing steps S4 to S6. Then, since the requested user does not give an answer whether or not to approve, it is possible to further reduce the burden of the requested user and save the requested user's time and trouble.

Note that in the first embodiment, if the answer from the requested user received from the requested terminal 3b indicates approval of the request, the server 2 transmits the inquiry about approval of the request to the approving terminal 3c, whereas if the answer indicates disapproval of the request, the server 2 does not transmit the inquiry to the approving terminal 3c. Then, since no inquiry will be sent to the approving user if the requested user does not approve, the approving user does not need to give an answer if there is no need to do so. Thus, it is possible to reduce the operation burden of the approving user.

In the first embodiment (also in the second embodiment to be described below), the server 2 issues an inquiry about a request to the requested user before transmitting an inquiry to the terminal device of the approving user (the approving terminal 3c) (step S4). That is, the server 2 notifies the requested terminal 3b that there has been a request from the requesting user to the requested user before transmitting an inquiry to the approving terminal 3c. Then, even though the approval is done by the approving user, the server 2 can notify in advance the requested user that a request has been made. There are cases where a friend request is clearly not fraudulent, and the requestee himself/herself can properly decide whether or not to approve the request, as in a case where the requester is an actual friend of the requestee, for example. In such a case, since the requested user is notified in advance that a friend request has been made (i.e., before an inquiry is issued to the approving user), the requested user can tell the approving user in advance to approve the friend request. Therefore, it is possible to reduce the possibility that a friend request is erroneously disapproved by the approving user.

Note that in an alternative embodiment, when there is a friend request, the server 2 may issue an inquiry to the approving terminal 3c before notifying the requested terminal 3b, and (only) if the answer of the approving user received from the approving terminal 3c indicates approval of the request, the server 2 gives the notification to the requested terminal 3b (e.g., a notification that a request has been made and a notification that a request has been approved). Then, since those friend requests that are not approved will not be notified to the requested user, it is possible to save the requested user's time and trouble for checking.

In the first embodiment (also in the second embodiment to be described below), when an inquiry about approval of a friend request is transmitted to the approving terminal 3c, the server 2 transmits, together with the inquiry, at least a part of profile information (the viewable information 23) saved for the requesting user. Then, with reference to the information of the profile, it becomes easier for the approving user to decide whether or not to approve. Note that in an alternative embodiment, the server 2 may transmit link information for accessing the webpage on which the profile information can be viewed, instead of transmitting the profile information.

(Process of Viewing User Information)

Next, the process in which a user views information (the viewable information, etc.) of another user in the SNS will be described. In the present embodiment, for each user of the SNS, the server 2 has, saved in the data storage section 14, data of a webpage for displaying information regarding the user such as the viewable information. In the website of the SNS, by accessing a webpage of another user of interest, the webpage can be displayed on the terminal device and the user can view information regarding the other user.

Specifically, when the webpage of another user of interest (the viewed user) is viewed by a viewing user (the viewing user), an access request to access the webpage is issued to the server 2. That is, in response to an instruction of the viewing user, the terminal device 3 of the viewing user transmits an access request to the server 2.

When the access request is received, the server 2 determines whether or not the viewing user who has issued the access request is a friend of the viewed user (whether or not the viewing user is registered as a friend of the viewed user). This determination is made based on the friend information 26 included in the user information 21 of the viewed user and the identification information of the viewing user included in the access request. That is, if the identification information of the viewing user is included in the friend information 26, it is determined that the viewing user is registered as a friend, and if the identification information of the viewing user is not included in the friend information 26, it is determined that the viewing user is not registered as a friend.

If it is determined that the viewing user is not registered as a friend, the server 2 transmits, to the terminal device 3 of the viewing user, data of a webpage that includes the non-restricted information 25 and does not include the restricted information 24, of all the viewable information 23 in the user information 21 of the viewed user. On the other hand, if it is determined that the viewing user is registered as a friend, the server 2 transmits, to the terminal device 3 of the viewing user, data of a webpage that includes the restricted information 24 and the non-restricted information 25, of all the viewable information 23 in the user information 21 of the viewed user. Thus, only when the viewing user is registered as a friend, the terminal device 3 of the viewing user can obtain a webpage that includes the restricted information 24 of the viewed user, and only then can the viewing user view the restricted information 24 of the viewed user.

Note that the method by which a user views information of another user in the SNS (e.g., a method where a user is allowed to view restricted information only when the user is registered as a friend) may be arbitrary, and may be similar to any of the conventional methods.

### 3. Specific Example of Process by Server 2

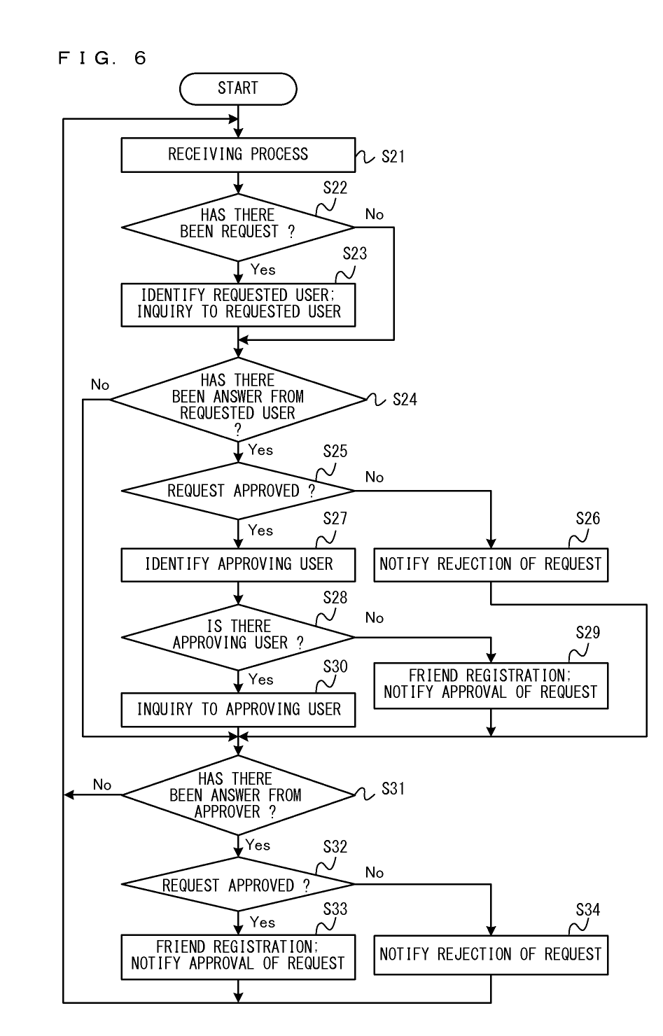

Referring now to FIG. 6, a specific example of a friend registration process to be performed by the server 2 of the first embodiment will be described. FIG. 6 is a flow chart showing an example of a flow of an information process performed by the server 2 (the control section 12) in the present embodiment. In the present embodiment, the series of processes shown in FIG. 6 are performed by the CPU of the control section 12 executing an information processing program stored in the program storage section 13. Note that FIG. 6 shows a process for the friend registration, and other processes performed by the server 2 (e.g., the process of allowing a user to view information of another user, etc.) will not be shown as they may be similar to those of conventional techniques.

Note that in the present request, the processes of the steps of the flow chart shown in the figures are merely illustrative, and the order of steps to be performed may be switched around, and different processes may be performed in addition to (or instead of) the processes of the steps, as long as similar results are obtained. While the present specification assumes that the processes of the steps of the flow chart are performed by the CPU, processes of some of the steps of the flow chart may be performed by a processor or a dedicated circuit other than the CPU. Note that the information process shown in FIG. 6 may be started at any point in time.

In the process shown in FIG. 6, first in step S21, the CPU receives data (information) transmitted from the terminal devices 3. That is, the CPU obtains data of request information of a friend request, and/or data of an answer from the terminal device 3 for an inquiry from the server 2, received via the communication section 11.

In step S22, the CPU determines whether or not a friend request has been made, i.e., whether or not a friend request has been received in the receiving process of step S21. If the determination result of step S22 is affirmative, in step S23, the CPU identifies the requested user of the received friend request (see step S3), and issues an inquiry about the friend request to the identified requested user (the requested terminal 3b) (see step S4). As described above, in response to the inquiry, an answer is transmitted from the requested terminal 3b (see step S6). As a result, in the process of step S21, the answer is received by the server 2.

In step S24, the CPU determines whether or not there has been an answer from the requested user, i.e. whether or not an answer from the requested terminal 3b has been received in step S21. If the determination result of step S24 is affirmative, the CPU determines in step S25 whether or not the answer received from the requested user indicates approval of the request. If the determination result of step S25 is negative, the CPU determines in step S26 that the friend request is not approved, and notifies the requesting user (and the requested user) that the friend request has been rejected (not approved). This notification process is similar to the process of step S13.

On the other hand, if the determination result of step S25 is affirmative, the CPU in step S27 identifies the approving user for the requested user based on the approver information 27 of the user information 21 of the requested user (see step S7). In step S28 to follow, the CPU determines whether an approving user for the requested user has been set. That is, the CPU determines whether the approving user has been identified in the process of step S27. Specifically, it is determined that the approving user has been identified when the user information 21 of the requested user includes the approver information 27, and it is determined that the approving user has not been identified when the approver information 27 is not included therein.

If the determination result of step S28 is negative, the CPU in step S29 performs a friend registration in which the requesting user is registered as a friend of the requested user, and notifies the requesting user and the requested user that the friend request has been approved. The process of step S29 is similar to the process of steps S12 and S13.

On the other hand, if the determination result of step S28 is affirmative, the CPU in step S30 issues an inquiry to the identified approving user (see step S8). As described above, an answer is transmitted from the approving terminal 3c in response to the inquiry (see step S10). Then, the answer is received by the server 2 in the process of step S21.

As described above, in the present embodiment, if the requested user does not approve the friend request (No in step S25), it is decided that the friend request is not approved without issuing an inquiry to the approving user (step S26). If the requested user approves the friend request (Yes in step S25) and if no approving user is set for the requested user (No in step S28), it is decided that the friend request is approved without issuing an inquiry to the approving user (step S29).

In step S31, the CPU determines whether or not there has been an answer from the approving user, i.e., it is determined in step S21 whether or not an answer has been received from the approving terminal 3c. If the determination result of step S31 is affirmative, the CPU determines in step S32 whether or not the answer received from the approving user indicates approval of the request. If the determination result of step S32 is affirmative, the CPU in step S33 performs a friend registration in which the requesting user is registered as a friend of the requested user (see step S12), and notifies the requesting user and the requested user that the friend request has been approved (see step S13). On the other hand, if the determination result of step S32 is negative, the CPU in step S34 notifies the requesting user (and the requested user) that the friend request has been rejected, as in step S26.

The CPU of the server 2 repeatedly performs the processes of S21 to S31, thereby performing the process of the server 2 shown in FIG. 4.

### Second Embodiment

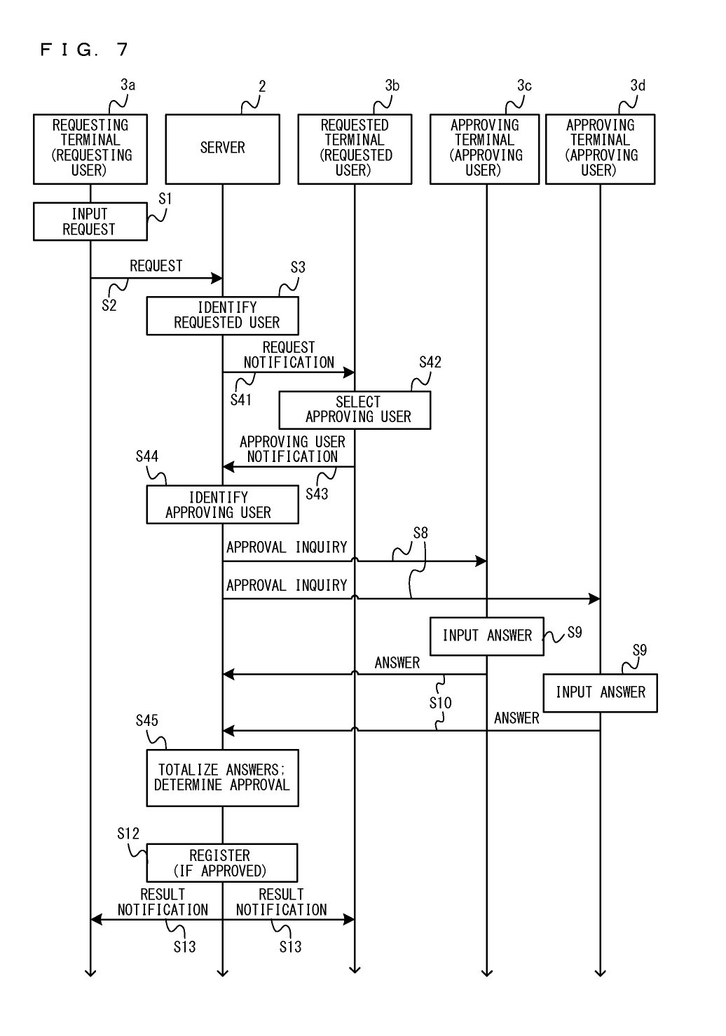

Next, referring to FIGS. 7 to 9, processes performed by an information processing system according to a second embodiment will be described. In the first embodiment, an approving user is predetermined for the requested user, and when there is a friend request, an inquiry is issued to the predetermined approving user. In contrast, in the second embodiment, the requested user selects an approving user for each friend request. The second embodiment is applicable to a case where, for example, when a friend request, of which the legitimacy is dubious, has been made to a requested user, the requested user asks an already-registered friend user to approve/disapprove the request.

Note that the following description of the second embodiment will focus on differences from the first embodiment, and like configurations or operations (processes) to those of the first embodiment may not be described below. Moreover, like elements or processes to those of the first embodiment will be denoted by like reference signs or step numbers to those of the first embodiment, and may not be described in detail.

[1. Outline of Process in Second Embodiment]

The configuration of the information processing system of the second embodiment is similar to that of the first embodiment (see FIG. 1). Note however that the friend information 26 is not set in advance in the user information 21 of the requested user, stored in the server 2. Also in the following description, processes will be described with respect to an example where two uses are set as approving users, and the approving users use different terminal devices (an approving terminal 3c and an approving terminal 3d shown in FIG. 7).

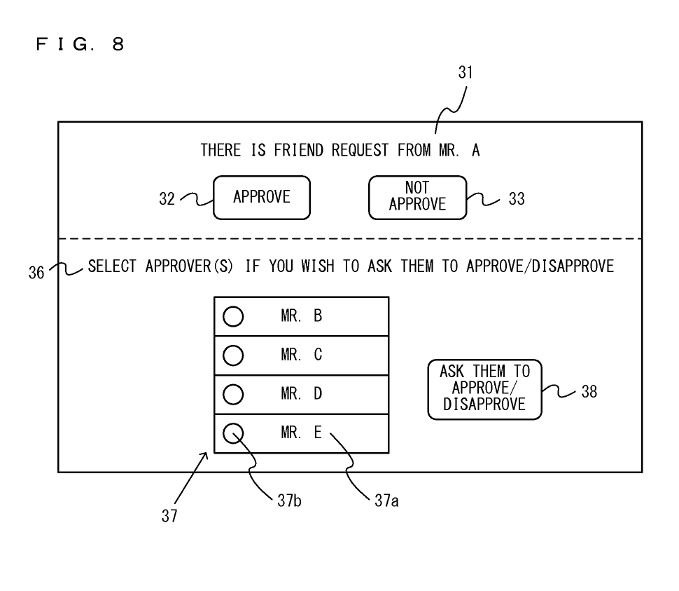

FIG. 7 is a timing diagram showing a flow of a friend registration process in the second embodiment. In the second embodiment, when the requested user is identified (step S3), the server 2 transmits a notification (request notification) to the requested terminal 3b, notifying that a friend request has been made (step S41). That is, the server 2 updates the user information 21 so that the notification information 28 regarding the request notification is included in the user information 21 of the requested user. Now, the request notification is a notification for making the requested user either give an answer indicating whether or not to approve the friend request or select an approving user. Therefore, as the transmit information to be transmitted upon request notification, the notification information 28 includes information of an answer screen (see FIG. 8) for making the requested user give an answer for an inquiry about approval of the friend request and select an approving user. Then, when the requested user accesses the server 2 using the requested terminal 3b and logs in to the SNS, the transmit information is transmitted from the server 2 to the requested terminal 3b, and the answer screen is displayed on the display device of the requested terminal 3b.

FIG. 8 is a diagram showing an example of an answer screen to be shown on the requested terminal 3b upon receiving a request notification. As shown in FIG. 8, the answer screen includes the message 31 and the button images 32 and 33, as in the inquiry screen shown in the first embodiment. Note that although not shown in FIG. 8, the answer screen may include information such as a profile of the requesting user.

As shown in FIG. 8, the answer screen includes a message 36 prompting the requested user to select an approving user if the requested user asks for approval/disapproval of the friend request, a list 37 of candidate approving users, and an image (button image) 38 for instructing to ask for approval/disapproval. The candidate list 37 includes names (account names) 37a of candidate users of approving users, and check boxes 37b indicating whether the candidate users are being selected. The requested user selects an approving user from among the users in the candidate list 37 by using the input device, and selects the button image 38, which reads “ASK THEM TO APPROVE/DISAPPROVE”, to determine the approving user.

Note that in the present embodiment, users included in the candidate list 37 as candidates for approving users are registered friends of the requested user (users who have been already registered as friends with the requested user). That is, in step S41, the server 2 identifies users who are registered friends of the requested user based on the friend information 26 in the user information 21 regarding the requested user. Then, the candidate list 37 including the identified users is created, and the candidate list is stored, included in the transmit information in the notification information 28. The candidate list includes information of the identification information and/or name of each user who is a candidate for an approving user.

Note that the method for identifying users to be candidates for approving users may be any method. For example, in an alternative embodiment, the server 2 may use, as candidates, registered friends of the requesting user in addition to (or instead of) registered friends of the requested user. For example, the server 2 may use, as candidates, users who are registered friends of the requested user and are also registered friends of the requesting user. For example, approving users may be designated by the operator of the SNS, and the designated approving users may be added to the list of candidates.

In response to a request notification, the requested user makes an input to either give an answer indicating whether or not to approve the friend request, or select an approving user and ask for approval/disapproval. FIG. 7 shows a case where an input is made to select an approving user and ask for approval/disapproval (step S42), in which case the requested terminal 3b notifies the server 2 of the selected approving user (step S43). This notification includes information for identifying the selected approving user (the identification information, the name, etc.).

When the information of the selected approving user is notified from the requested terminal 3b to the server 2, the server 2 identifies the approving user based on the received notification (step S44). Then, the identification information of the identified approving user is stored, in the data storage section 14, as the approver information 27 in the user information 21 of the requested user.

The operation of issuing an inquiry from the server 2 to the approving terminal of the identified approving user, inputting an answer for the inquiry at the approving terminal, and transmitting the answer result from the approving terminal to the server 2 is similar to the operation in steps S8 to S10 of the first embodiment. Note however that in the second embodiment, the operation in steps S8 to S10 may be performed between the server 2 and a plurality of approving terminals (see FIG. 7).

When the server 2 receives answer results from all the approving terminals 3c and 3d to which the inquiry has been issued, the server 2 totalizes the answer results to determine whether or not to approve the friend request based on the totaled result (step S45). Where there are a plurality of approving users, the server 2 makes the determination based on whether a plurality of answer results satisfy a predetermined condition. The predetermined condition may be any condition, e.g., based on majority rule for the answer results (whether the number of answers to approve is greater than the number of answers not to approve), or whether the number of answers to approve is greater than or equal to a predetermined number.

In an alternative embodiment, instead of receiving answers indicating whether or not to approve the friend request from approving terminals, the server 2 may receive from the approving terminals an index (a score, etc.) representing the degree to which approval is supported, as answers regarding the approval of the friend request. Then, whether or not to approve the friend request may be determined based on whether or not the value obtained by totalizing indices received from the approving terminals satisfies a predetermined condition. For example, the server 2 may receive score information as answers from the approving terminals, and may approve the friend request on the condition that the total value (or the average value) of the received scores is greater than or equal to a predetermined value.

The processes of the server 2 after it is determined whether or not to approve the friend request are similar to the first embodiment. That is, if it is determined that the friend request is approved, the requesting user is registered as a friend of the requested user (step S12). The server 2 also notifies the determination result (irrespective of the determination result) to the requesting user and the requested user (step S13). In the second embodiment, the server 2 at this point deletes the approver information 27 stored in the data storage section 14 in step S44.

[2. Specific Example of Process of Server 2 in Second Embodiment]

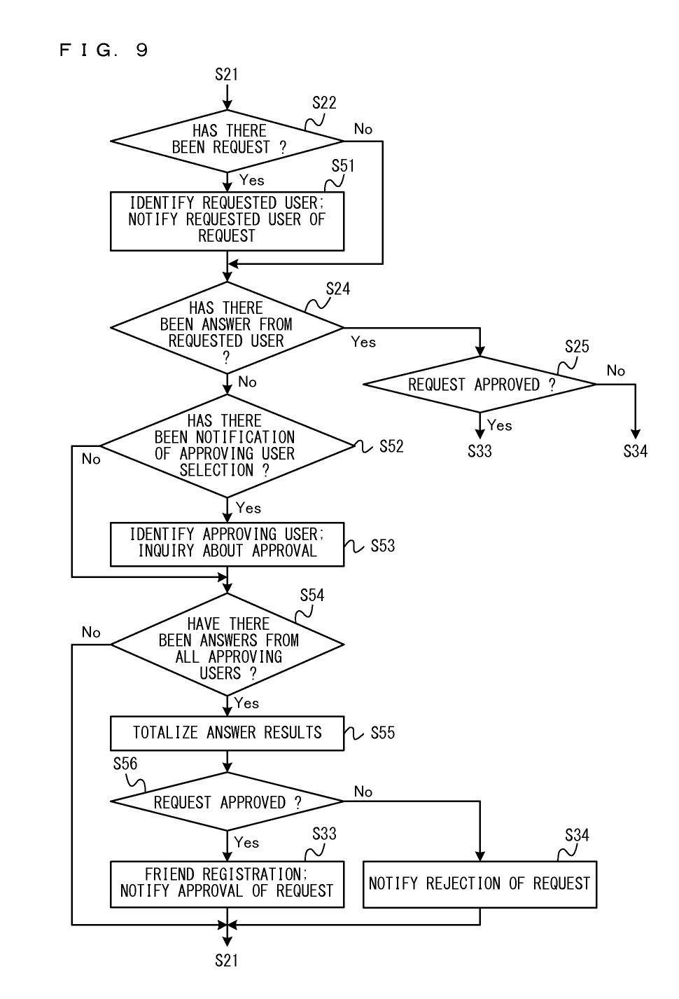

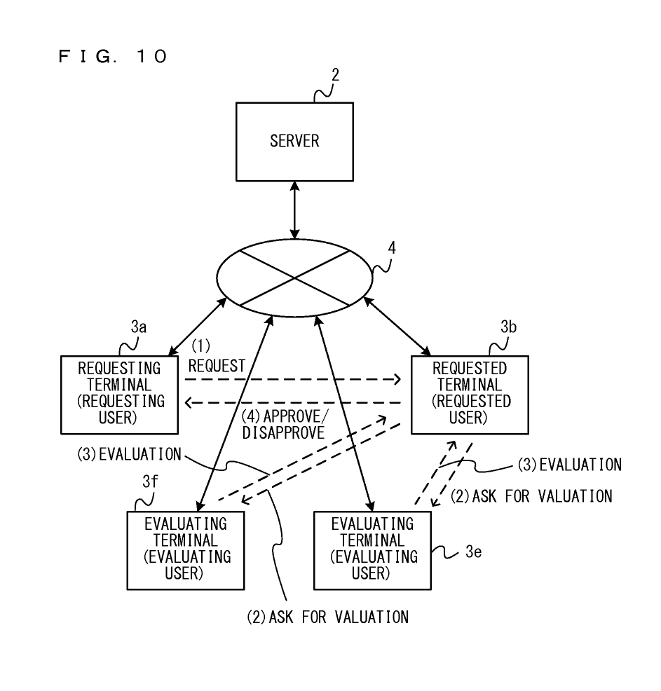

Referring now to FIG. 9, a specific example of a friend registration process to be performed by the server 2 of the second embodiment will be described. FIG. 9 is a flow chart showing an example of a flow of an information process performed by the server 2 (the control section 12) in the second embodiment. Note that FIG. 9 shows the process flow focusing on the differences from the first embodiment, and like processes to those of the first embodiment (FIG. 6) are denoted by like step numbers and will not be described in detail.

In the second embodiment, if the determination result of step S22 is affirmative, the CPU in step S51 identifies the requested user for the received friend request (see step S3), and transmits the request notification described above to the identified requested user (the requested terminal 3b) (see step S41). As described above, in response to this request notification, either an answer indicating whether or not to approve the friend request or a notification of a selected approving user is transmitted from the requested terminal 3b (see step S43). Then, through the process of step S21, the answer or the notification is received by the server 2.

In the second embodiment, the process of step S24 is performed if the determination result of step S22 is negative or following the process of step S51. That is, in step S24, the CPU determines whether or not there has been an answer from the requested user. If the determination result of step S24 is affirmative, it is determined in step S25 whether or not the received answer of the requested user indicates approval of the request. If the determination result of step S25 is affirmative, the process of step S33 is performed, and if the determination result of step S25 is negative, the process of step S34 is performed. That is, whether or not to approve the friend request is determined based on the answer from the requested user, and processes are performed depending on the determination.

On the other hand, if the determination result of step S24 is negative, the CPU determines in step S52 whether or not there has been a notification of an approving user selected by the requested user, i.e., whether or not the notification is received from the requested terminal 3b in step S21. If the determination result of step S52 is affirmative, the CPU in step S53 identifies the approving user based on the notification from the requested user (see step S44), and an inquiry is issued from the server 2 to the approving terminal of the identified approving user (see step S8). As described above, an answer is transmitted from the approving terminal in response to the inquiry (see step S10). Then, the answer is received by the server 2 in the process of step S21. In the present embodiment, the CPU stores the received answer in the memory in the control section 12 or in the data storage section 14.

In step S54, the CPU determines whether or not answers have been received from all approving users selected by the requested user. If the determination result of step S54 is affirmative, the CPU totalizes the answer results from the approving users in step S55. For example, as the totaled result, the CPU calculates, and stored in the memory, the number of answer results indicating to approve and the number of answer results indicating not to approve. In the following step S56, the CPU reads out the totaled result stored in the memory to determine whether or not to approve the friend request based on the totaled result (see step S45). This determination is made, for example, based on whether the number of answer results indicating to approve exceeds the number of answer results indicating not to approve.

If the determination result of step S56 is affirmative, the process of step S33, similar to that of the first embodiment, is performed, and if the determination result of step S56 is negative, the process of step S34, similar to that of the first embodiment, is performed.

As described above, in the second embodiment when the friend request is received, the server 2 transmits an inquiry (request notification) for selecting an approver (approving user) for the friend request to the requested terminal 3b (step S41), and receives information indicating a selected approving user from the requested terminal 3b (step S43). Then, the server 2 identifies an approver based on the received information indicating the approving user (step S44). Therefore, in the second embodiment, the requested user can set an approving user for each friend request, and it is possible to select an appropriate approving user depending on the requesting user. For example, if the requesting user is a colleague from the workplace of the requested user, the requested user can select a registered friend who is also their colleague as an approving user, or if the requesting user is a graduate from the same school as the requested user, the requested user can select a registered friend who is also a graduate from the same school as an approving user.

In the first and second embodiments, the server 2 receives information regarding whether or not to set an approving user from the terminal device of the requested user, and determines whether or not to set an approving user based on the received information. Then, if it is determined that an approving user is to be set, the server 2 identifies the approving user (step S44). Thus, according to the second embodiment, since the requested user is allowed to choose whether or not to set an approving user, the requested user can decide whether or not to approve a friend request by himself/herself, or can ask another user to approve/disapprove. Thus, it is possible to reduce the burden on the requested user for the approval decision, and (if the requested user decides that there is no need to ask for approval/disapproval) it is possible to easily register the requesting user as a friend.

In the second embodiment, the server 2 may identify a plurality of approving users (see FIG. 7). Then, the server 2 transmits an inquiry to each of the terminal devices of the identified approving users, and receives an answer from each of the terminal devices. From the received answers, the server 2 calculates a value representing the degree to which approval is supported (e.g., the number of approving users answering to approve; which can be said to be a value also representing the degree to which approval is not supported) to determine whether or not to approve the request based on whether or not the calculated value satisfies a predetermined condition. Then, where a plurality of approving users are set, it is possible to easily decide whether or not to approve.

### Third Embodiment

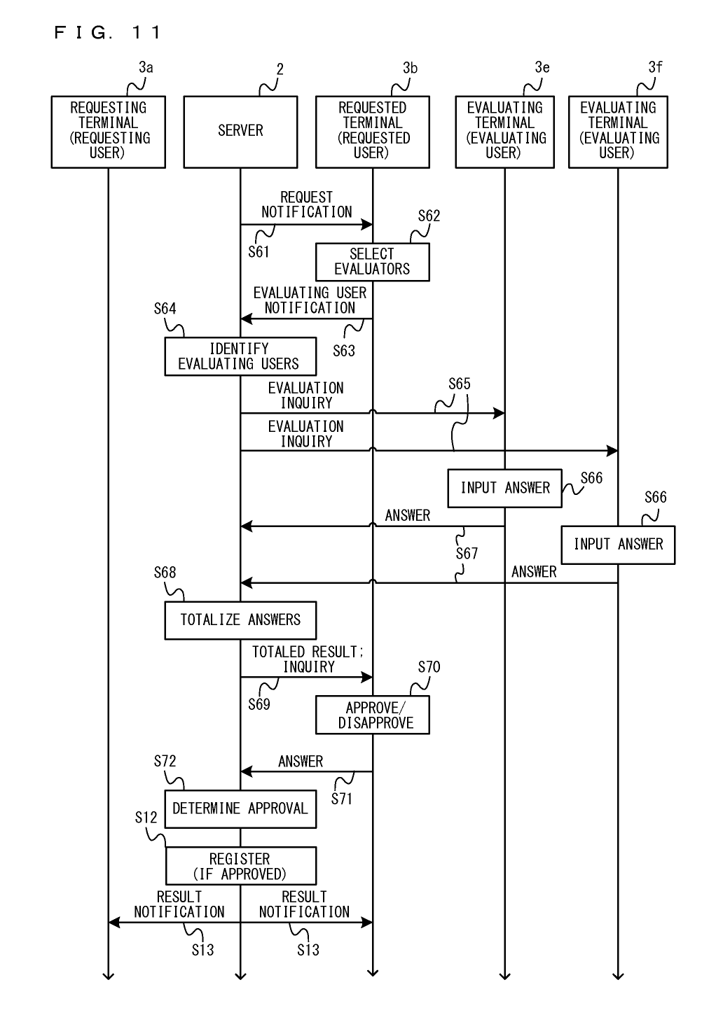

Next, referring to FIGS. 10 to 13, processes performed by an information processing system according to a third embodiment will be described. In the first and second embodiments, the requested user asks another user to approve/disapprove a friend request. In contrast, in the third embodiment, the requested user asks another user to evaluate a friend request (i.e., the requesting user) so that the requested user can decide whether or not to approve the friend request himself/herself with reference to the evaluation. The third embodiment is applicable to a case where, for example, when a friend request, of which legitimacy is dubious, has been made to a requested user, the requested user asks friend users to evaluate the request.

Note that the following description of the third embodiment will focus on differences from the first and second embodiments, and like configurations or operations (processes) to those of the first and second embodiments may not be described below. Moreover, like elements or processes to those of the first and second embodiments will be denoted by like reference signs or step numbers to those of the first and second embodiments, and may not be described in detail.

[1. Outline of Process in Third Embodiment]

Referring now to FIGS. 10 to 12, an outline of a friend registration process to be performed by the information processing system 1 of the third embodiment will be described. FIG. 10 is a diagram generally showing a flow of an operation when a friend registration is performed. A process performed by the information processing system 1 as shown in FIG. 10 will now be described where a requesting user issues a friend request to a requested user ((1) shown in FIG. 10), the requested user asks an evaluating user to approve/disapprove ((2) shown in FIG. 10), the evaluating user notifies the requested user of an evaluation of the requesting user ((3) shown in FIG. 10), and the requested user approves/disapproves with reference to the evaluation ((4) shown in FIG. 10). Also in the following description, processes will be described with respect to an example where two users are set as evaluating users, and the evaluating users use different terminal devices (an evaluating terminal 3e and an evaluating terminal 3f shown in FIG. 10).

The configuration of the information processing system of the third embodiment is similar to that of the first embodiment (see FIG. 1). Note however that the content of the user information 21 of the requested user, stored in the server 2, is different from that of the first embodiment. That is, in the third embodiment, the evaluator information is included in the user information 21, instead of the approver information 27. The evaluator information represents identification information of another user (evaluating user) who has an authority to evaluate a friend request to the user (in other words, to evaluate the requesting user). That is, the evaluator information is set in a case where a user asks other users to evaluate a friend request. If the evaluator information is set in the user information 21, a friend request to the user associated with the user information 21 is evaluated by evaluating users represented by the evaluator information (the details of which will be described later).

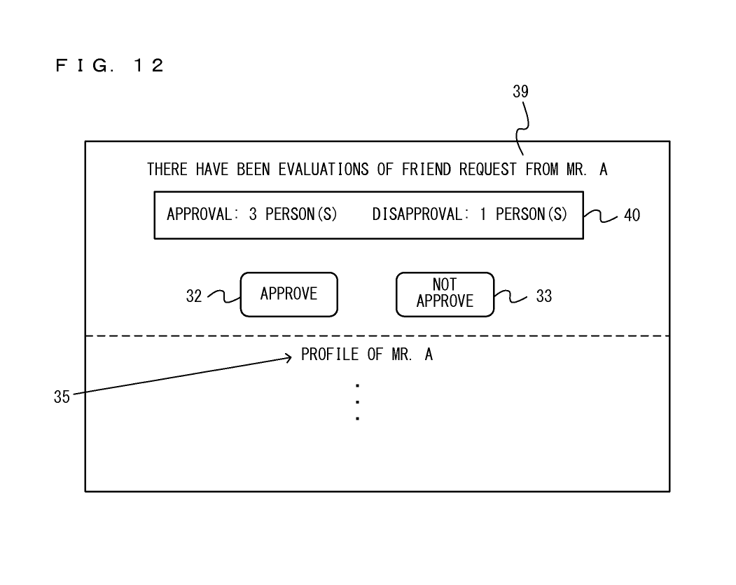

FIG. 11 is a timing diagram showing a flow of a friend registration process in the third embodiment. Note that although not shown in FIG. 11, the process in which a friend request is input on the requesting terminal 3a and transmitted to the server 2, and the requested user is identified by the server 2 (steps S1 to S3) is similar to that of the first embodiment.

In the third embodiment, when the requested user is identified, the server 2 transmits, to the requested terminal 3b, a notification (request notification) that a friend request has been made (step S61). This request notification is similar to step S41 of the second embodiment except that evaluating users are selected in the third embodiment, whereas approving users are selected in the second embodiment. The method of determining users to be candidate evaluating users, to be presented to the requested user on the answer screen, is also similar to that of the second embodiment.

In response to the request notification, the requested user makes an input to either give an answer indicating whether or not to approve the friend request, or select evaluating users and ask for evaluation. FIG. 11 shows a case where an input is made to select evaluating users and ask for evaluation (step S62), in which case the requested terminal 3b notifies the server 2 of the selected evaluating users (step S63). This notification includes information for identifying the selected evaluating users (the identification information, the name, etc.).

When the information of the selected evaluating users is notified from the requested terminal 3b to the server 2, the server 2 identifies the evaluating users based on the received notification (step S64). The server 2 issues an inquiry from the server 2 to the evaluating terminals 3e and 3f of the identified evaluating users (step S65). Answers for the inquiry (evaluations of the friend request) are input on the evaluating terminals 3e and 3f (step S66). When the answers are input, the evaluating terminals 3e and 3f transmit the answer results to the server 2 (step S67). The process of steps S65 to S67 is similar to the process of steps S8 to S10 in the first and second embodiments except that an answer input on an evaluating terminal is an evaluation of the friend request.

In the third embodiment, the answer (evaluation) input on an evaluating terminal may be any answer as long as it represents the evaluation of the friend request. For example, a value representing the degree to which approval is supported may be input as the answer, or an answer indicating whether or not to approve may be input as in the first and second embodiments. A comment (message) from the evaluating user may be input as the answer.

When the server 2 receives the answer results from all the evaluating terminals 3e and 3f to which the inquiry has been issued, the server 2 totalizes the answer results (step S68). For example, where the answer result is a value representing the degree to which approval is supported, a total value or an average value of these values may be calculated as the totaled result. Where the answer result is information indicating whether or not to approve, for example, the number of answers indicating to approve, and/or the number of answers indicating not to approve may be calculated as the totaled result. Note that in an alternative embodiment, the process of calculating the totaled result does not need to be performed, and the server 2 may transmit the answer results (evaluation results) from the evaluating terminals, as they are, to the requested terminal 3b in step S69 to be described below.

After calculating the totaled result, the server 2 transmits the inquiry about whether or not to approve the friend request, together with the totaled result included therein, to the requested terminal 3b (step S69). The method of transmitting the inquiry including the totaled result therein to the requested terminal 3b is similar to the method of transmitting the inquiry in step S4. Specifically, in the third embodiment, the server 2 transmits to the requested terminal 3b information for displaying an inquiry screen including an image for inputting an answer (approval/disapproval) for the friend request, while presenting the totaled result, and the inquiry screen is displayed on the requested terminal 3b.

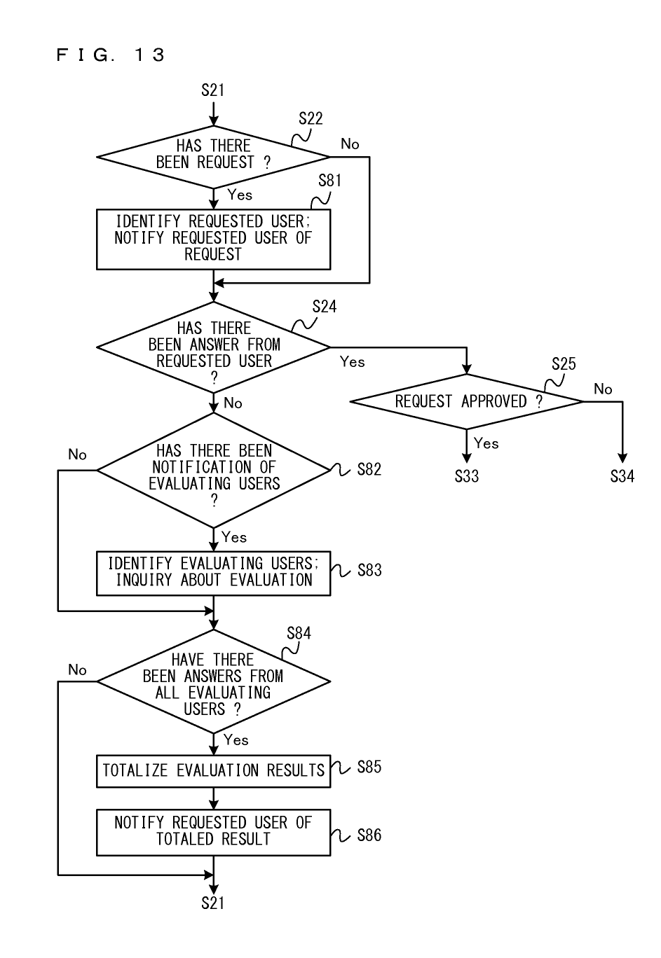

FIG. 12 is a diagram showing an example of an inquiry screen in the third embodiment. As shown in FIG. 12, the inquiry screen includes a message 39 indicating that there have been evaluations from the approving users, and an image 40 representing the totaled result of the evaluations. The inquiry screen includes the button images 32 and 33 similar to those of the first embodiment, and the profile 35 of the requesting user. With reference to the totaled result (and the profile 35) represented by the image 40, the requested user inputs an answer indicating whether or not to approve the friend request by using the button images 32 and 33. In response to the input, the requested terminal 3b transmits to the server 2 information representing the answer result (approval or disapproval) as in step S6 in the first embodiment (step S71).

The server 2 receives the answer transmitted from the requested terminal 3b, and determines whether or not to approve the friend request based on the answer (step S72). Then, if it is determined that the friend request is approved, the requesting user is registered as a friend of the requested user as in the first and second embodiments (step S12). Moreover, the server 2 notifies the determination result to the requesting user and the requested user as in the first and second embodiments (step S13).

[2. Specific Example of Process of Server 2 in Third Embodiment]

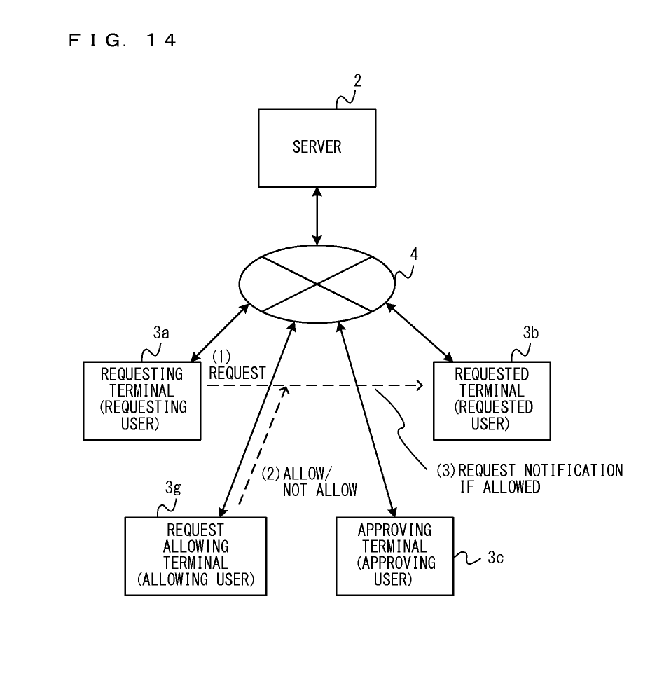

Referring now to FIG. 13, a specific example of a friend registration process to be performed by the server 2 of the third embodiment will be described. FIG. 13 is a flow chart showing an example of a flow of an information process performed by the server 2 (the control section 12) in the third embodiment. Note that FIG. 13 shows the process flow focusing on the differences from the first and second embodiments, and like processes to those of the first embodiment (FIG. 6) are denoted by like step numbers and will not be described in detail.

In the third embodiment, the process of steps S81 to S84 is performed instead of the process of steps S51 to S54 in the second embodiment. The process of steps S81 to S84 is similar to the process of steps S51 to S54 except whether it is a process regarding approving users or it is a process regarding evaluating users.

In the third embodiment, if the determination result of step S84 is affirmative, the process of step S85 is performed. In step S85, the CPU totalizes the answer results (evaluation results) received from the evaluating users. In step S86, following step S85, the CPU notifies the totaled result to the requested user (the requested terminal 3b). As described above, in response to this notification, the answer indicating whether or not to approve the friend request is transmitted from the requested terminal 3b (see step S71). As this answer is received by the server 2 in the process of step S21, the determination result of step S24 becomes affirmative, and it is determined by the server 2 in step S25 whether or not to approve the friend request.

As described above, in the third embodiment, the server 2 identifies another user separate from the requested user as an evaluator (evaluating user) who has an authority to evaluate the request made to the requested user (steps S64 and S81). Then, the server 2 transmits an inquiry about evaluation of the requesting user to the evaluating terminals 3e and 3f (steps S65 and S81), and receives answers for the inquiry from the evaluating terminals 3e and 3f (step S67). The server 2 transmits an inquiry about approval of a friend request, together with the evaluation information (totaled result) obtained based on the received answers, to the requested terminal 3b (step S69), and receives an answer for the inquiry from the requested terminal 3b (step S71). Moreover, the server 2 determines whether or not to approve the friend request based on the answer received from the requested terminal 3b (step S72) and, if it is determined that the friend request is approved, stores the identification information of the requesting user as a registered user (friend) with the requested user. Then, the requested user can ask evaluators (evaluating users) to evaluate the friend request made to himself/herself, and can decide whether or not to approve the friend request with reference to the evaluation by the evaluators. Thus, it is possible to reduce the burden on the requested user of deciding whether or not to approve the friend request.

In the third embodiment, the requested user sets evaluating users each time a friend request is made. That is, when there is a friend request, the server 2 transmits to the requested terminal 3b an inquiry for selecting evaluating users for the friend request (step S61), and receives information representing selected evaluating users from the requested terminal 3b (step S63). Then, the server 2 identifies the evaluating users based on the received information representing the evaluating users (step S64). Then, the requested user can set evaluating users for each friend request, and it is possible to select appropriate evaluating users depending on the requesting user.

In the third embodiment, each time a friend request is made, the requested user chooses whether or not to set evaluating users. That is, the server 2 transmits an inquiry about whether or not to set evaluating users to the requested terminal 3b (steps S61 and S81), and determines whether or not to set evaluating users based on the answer from the requested terminal 3b (steps S24 and S82). Then, if it is determined that evaluating users are to be set, the server 2 identifies evaluating users (step S83). Thus, it is possible to reduce the burden on the requested user of the approval decision, and it is also possible to easily register the requesting user as a friend (if it is determined that there is no need to ask for evaluation).

Note that in an alternative embodiment, as in the method of setting an approving user in the first embodiment, the server 2 may store in the storage device, for at least one user, identification information of an evaluating user who has an authority to evaluate a friend request made to the user, in advance prior to the friend request. Then, the server 2 may identify the evaluating user based on the identification information of the evaluating user stored in the storage device. Then, the requested user does not need to select an evaluating user for each friend request, thereby making it possible to easily set an evaluating user.

In the third embodiment, when transmitting an inquiry about evaluation of the requesting user to the evaluating terminal, the server 2 transmits, together with the inquiry, at least a part of profile information (the viewable information 23) saved for the requesting user. Then, with reference to the information of the profile, it becomes easier for the evaluating user to make an evaluation.

In the third embodiment, the server 2 may identify a plurality of evaluating users (see FIG. 10). Then, the server 2 transmits an inquiry to each of the terminal devices of the evaluating users, and receives an answer from each of the terminal devices. From the received answers, the server 2 calculates a parameter indicating an evaluation index (totaled result), and transmits, together with the calculated parameter, an inquiry about approval of the friend request to the requested terminal 3b. Then, where a plurality of evaluating users are set, it is possible to present the evaluation results to the requested user in an easy-to-understand manner, and therefore it becomes easier for the requested user to decide whether or not to approve.

Variations>

(Variation where Request Allowing User is Set for Requesting User)

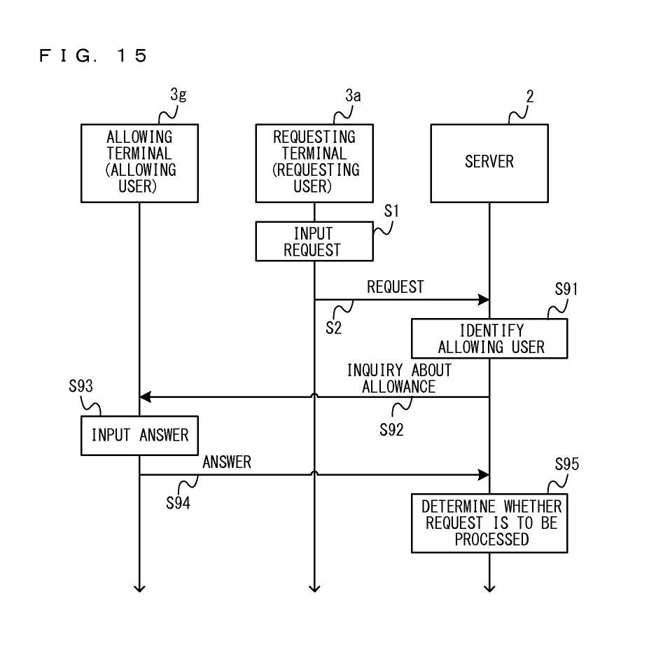

In a variation to the first to third embodiments, an allowing user separate from the requesting user may be set as a request allower who has an authority to allow a friend request to be made. FIG. 14 is a diagram generally showing an example of a flow of an operation when a friend request is made in a variation of the first embodiment. As shown in FIG. 14, in this variation, if a certain requesting user makes a friend request to a requested user ((1) shown in FIG. 14), the allowing user decides whether or not to allow the friend request ((2) shown in FIG. 14), and if allowed, the requested user is notified of the friend request ((3) shown in FIG. 14). Note that although it is assumed in FIG. 14 that the requesting terminal 3a used by the requesting user and an allowing terminal 3g used by the allowing user are separate terminal devices from each other, a single information processing device may be used as these terminals.

FIG. 15 is a timing diagram showing a flow of a friend request process in the variation shown in FIG. 14. First, as in the first embodiment, the requesting user inputs a friend request using the requesting terminal 3a (step S1), and the friend request is transmitted from the requesting terminal 3a to the server 2 (step S2).

In this variation, as the friend request is received from the requesting terminal 3a, the server 2 identifies an allowing user to be set for the requesting user (step S91). The allowing user can be identified by a similar method to the method of identifying an approving user to be set for the requested user. That is, the server 2 stores, included in the user information 21, information (identification information, etc.) with which it is possible to identify the allowing user to be set for the requesting user, as the allower information. When there is a friend request, the server 2 identifies the allowing user with reference to the allower information in the user information 21 of the requesting user. Note that if no allowing user is set for the requesting user, the server 2 identifies the requested user and issues an inquiry about the friend request to the requested terminal 3b, as in the first embodiment.

When the allowing user is identified, the server 2 issues an inquiry about whether or not to allow a friend request to be made to the allowing terminal 3g, which is the terminal of the allowing user (step S92). The method of transmitting the inquiry to the allowing terminal 3g is similar to the method of transmitting an inquiry to the requested terminal 3b in step S4. In step S92, information for displaying an inquiry screen on the allowing terminal 3g is transmitted as transmit information.

When the transmit information from the server 2 is received by the allowing terminal 3g, the allowing terminal 3g displays the inquiry screen on the display device. This inquiry screen includes an image for giving an answer indicating whether or not to allow the friend request to be made by the requesting user. The server 2 may transmit information of the name and/or the profile of the requested user for an inquiry, and the name and/or the profile of the requested user may be included in the inquiry screen.

When the inquiry screen is displayed on the allowing terminal 3g, the allowing user inputs an answer indicating whether or not to allow the friend request by inputting on the inquiry screen (step S93). In response to the input, the allowing terminal 3g transmits information representing the answer result (allowance or non-allowance) to the server 2 (step S94). The answer includes identification information of the requesting user, and the answer result indicating allowance or non-allowance of the friend request.

When the answer of the allowing user transmitted from the allowing terminal 3g is received, the server 2 determines whether or not to process the friend request (whether or not to notify the requested user of the friend request), in other words, whether or not the friend request is valid (step S95). If the received answer from the allowing user indicates allowance, the server 2 determines that the friend request is to be processed, and issues an inquiry about the friend request to the requested terminal 3b, as in the first embodiment, although not shown in the figures (see step S4). Then, if the requested user asks an approving user to approve/disapprove, an inquiry about whether or not to approve the friend request is issued to the approving user as in the first embodiment (see step S8).

On the other hand, if the received answer from the allowing user indicates non-allowance, the server 2 determines that the friend request is not to be processed, and notifies the requesting user that the friend request is not to be processed, although not shown in the figures.

Thus, in the variation described above, when the server 2 receives a friend request, the server 2 identifies another allowing user separate from the requesting user as a request allower who has an authority to allow a friend request to be processed (step S91). Then, the server 2 transmits an inquiry about allowance of the friend request to the allowing terminal 3g, and receives an answer for the inquiry from the allowing terminal 3g (step S94). If the received answer indicates that the friend request is allowed, the server 2 considers the friend request by the requesting user valid, whereas if the received answer indicates that the friend request is not allowed, the server 2 renders the request by the requesting user invalid (rejects the request). If the friend request is considered valid, an inquiry about approval of the friend request is transmitted to the approving terminal. Then, a requesting user can be restricted, by another allowing user, from making a friend request. For example, where the requesting user is a child, the requesting user may issue a friend request to a user whose legitimacy is dubious, which may result in registration of an illegitimate user as a friend. In contrast, according to the variation described above, by setting a parent (guardian) as the allowing user for the requesting user, it is possible to prevent a child from issuing a friend request to a dubious user.

Note that while the variation described above is applied to the first embodiment in the above description, this variation is also applicable to the second and third embodiments.

(Variation where Approver is not Registered User)

The first embodiment is directed to an example where the approving user is registered as a user of the SNS. In an alternative embodiment, someone who is not a user of the SNS may be set as the approver. As a variation to the first embodiment, a process of the information processing system 1 where the approver is not a registered user will now be described.

In this variation, it is assumed that the approver is not registered as a user of the SNS (hence assigned no identification information), and uses a predetermined information processing device capable of communicating with the server 2. In this variation, communication information (e.g., the email address, etc.) for communicating with the information processing device (approving device) used by the approver is stored in the data storage section 14 as the approver information 27.

When an inquiry is issued to the approver, the server 2 communicates with the approving device by using the communication information, thereby transmitting to the approving device transmit information for the inquiry. For example, the transmit information is transmitted via email by using the email address of the approving device. Although the transmit information may be of any specific content, the server 2 may provide a webpage similar to the inquiry screen described above, and transmit information (link information) for accessing the webpage as the transmit information, for example. This webpage (inquiry screen) may include the profile of the requesting user, as in the first embodiment. When the approving device receives the inquiry, the approver accesses the webpage to input an answer. The server 2 obtains the answer made on the webpage, and determines whether or not to approve the friend request based on the obtained answer (see step S11).

According to the variation described above, the server 2 saves the user information 21 for a user provided with an account, while the server 2 transmits an inquiry to an approver not provided with an account. Now, when an inquiry is transmitted to an approver not provided with an account, the server 2 transmits, to the information processing device of the approver, information including link information for accessing the webpage for giving an answer for the inquiry, and obtains the answer made on the webpage by the information processing device of the approver. Then, a person who has no account of the SNS can be appointed an approver. Since an approver who does not use the SNS does not need to do a user registration in order to approve requests, it is possible to save time and trouble of the approver who does not use the SNS. Note that in an alternative embodiment, answers may be obtained from approvers by the method of the variation described above not only from those who are not provided with accounts but also from those who are provided with accounts (the approving users in the first and second embodiments). Also in such a case, it is possible to provide similar effects to the variation described above.

Note that the variation described above is applicable not only to the first embodiment, but also to a case where an approver is set in the second embodiment. The variation described above is also applicable to a case where an evaluator is set in the third embodiment, and a case where a request allower is set as described above.

(Variation where there is No Answer from Approving User)

In the first and second embodiments, the server 2 determines whether or not to approve the friend request in response to receiving answers from (all) the approving users (see steps S31 and S54). In an alternative embodiment, if an answer for an inquiry is not received (from an approving terminal) within a predetermined period of time since the issuance of the inquiry to the approving user, the server 2 may consider it as being an answer for the inquiry indicating disapproval of the friend request. For example, where there is one approving user, if an answer for an inquiry is not received within a predetermined period of time since the issuance of the inquiry, the server 2 may determine that the friend request is not approved. For example, where there are a plurality of approving users, if an answer for an inquiry is not received from some of the approving users within a predetermined period of time since the issuance of the inquiry, the server 2 may consider it to mean that answers for the inquiry from those approving users indicate that the friend request is not approved. Then, upon passage of the predetermined period of time, whether or not to approve the friend request may be determined based on answers from the approving users. Then, even if an answer is not received from an approving user, the server 2 can still determine whether or not to approve the friend request.

(Variation where Friend Request is Retroactively Approved by Approving User)

In an alternative embodiment, in response to approval of a friend request by the requested user, the server 2 may temporarily register the requesting user as a friend of the requested user. Then, if the friend request is approved (retroactively approved) by the approving user within a predetermined period of time, the server 2 may non-temporarily register the requesting user as a friend of the requested user, whereas if the friend request is not approved (retroactively approved) by the approving user within a predetermined period of time, the server 2 cancels the temporary registration, disapproving the friend request. Thus, a temporary friend registration can be made quickly in response to the approval by the requested user, while a non-temporary friend registration can be made while taking into consideration the approval result by the approving user.

(Variation Regarding Name Under which Friend Request is Made and Approved)

In the above embodiments and variations, a friend request is made under the name of the requesting user himself/herself who has made the friend request. That is, the server 2 notifies the requested user that a friend request has been made from the requesting user (see FIG. 6). A friend request is approved/disapproved under the name of the requested user who has received the friend request. In an alternative embodiment, if an allowing user is set for the requesting user, the friend request from the requesting user may be notified to the requested user as having been made under the name of the allowing user. If an approving user is set for the requested user, the approval/disapproval by the approving user may be notified to the requesting user as having been made under the name of the approving user.

(Variation Regarding Combinations Between Above Embodiments)

The above embodiments are directed to an example of a user for whom an approving user is set in advance (the first embodiment), an example of a user for whom an approving user is set for each friend request (the second embodiment), and an example of a user for whom an evaluating user is set (the third embodiment). In an alternative embodiment, these users may coexist on a single SNS. Moreover, a user for whom an allowing user is set, as described in the variation described above, may also be included. In such a case, the server stores approver information, evaluator information and allower information as necessary, included in the user information. If approver information and evaluator information are not set in the user information of the requested user, the server may allow the requested user to choose between approving/disapproving the request by the requested user himself/herself, asking other users to approve/disapprove the request, and asking other users to evaluate the request, when the server notifies the requested user of the friend request.

(Variation Regarding Levels of Friend)

In the above embodiments, the server 2 presents the viewable information 23 so that the amount of the viewable information 23 that can be viewed by a user differs depending on whether the user is registered as a friend. In an alternative embodiment, the server 2 may set different levels of friend registration so that the amount of the viewable information 23 that can be viewed by a user differs depending on the level of the user. In such a case, a friend request is made for each level.

(Variation Regarding Authority Granted to Registered User)

The above embodiments are directed to examples where a registered user who is registered as a friend with a certain user is granted an authority to view predetermined information regarding the certain user. In an alternative embodiment, the authority to be granted to a registered user may be any authority. For example, the authority to be granted to a registered user registered as a friend with a certain user may be an authority to transmit information to the certain user (e.g., comments, messages, etc., in response to information, e.g., a journal, that has been posted by the certain user), or may be an authority to share data of the certain user (movie data, music data, etc.).

In an alternative embodiment, the server may be any server (server system) for saving information regarding a plurality of users, and providing predetermined information regarding a certain user to other users. For example, the server may be a game server for providing types of games such as on-line games and social games. In such a case, the authority to be granted to registered users may be such that users (players) registered as friends with each other are allowed to play the game together, or may be such that users registered as friends with each other are allowed to exchange data.

The above embodiments and variations can be used as a server system for providing an SNS, for example, with the aim of reducing the burden on a user of deciding whether or not to approve a request from other users.

The systems, devices and apparatuses described herein may include one or more processors, which may be located in one place or distributed in a variety of places communicating via one or more networks. Such processor(s) can, for example, use conventional 3D graphics transformations, virtual camera and other techniques to provide appropriate images for display. By way of example and without limitation, the processors can be any of: a processor that is part of or is a separate component co-located with the stationary display and which communicates remotely (e.g., wirelessly) with the movable display; or a processor that is part of or is a separate component co-located with the movable display and communicates remotely (e.g., wirelessly) with the stationary display or associated equipment; or a distributed processing arrangement some of which is contained within the movable display housing and some of which is co-located with the stationary display, the distributed portions communicating together via a connection such as a wireless or wired network; or a processor(s) located remotely (e.g., in the cloud) from both the stationary and movable displays and communicating with each of them via one or more network connections; or any combination or variation of the above.

The processors can be implemented using one or more general-purpose processors, one or more specialized graphics processors, or combinations of these. These may be supplemented by specifically-designed ASICs (application specific integrated circuits) and/or logic circuitry. In the case of a distributed processor architecture or arrangement, appropriate data exchange and transmission protocols are used to provide low latency and maintain interactivity, as will be understood by those skilled in the art.

Similarly, program instructions, data and other information for implementing the systems and methods described herein may be stored in one or more on-board and/or removable memory devices. Multiple memory devices may be part of the same device or different devices, which are co-located or remotely located with respect to each other.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. A server system for saving information regarding a plurality of users and providing predetermined information regarding a certain user to another user,
wherein one or more processor of the server system executes:
storing in a storage section, for each user, identification information of another user registered as a registered user who is granted a predetermined authority over information regarding the user;
receiving, from a terminal device of a first user, a request for registering the first user as a registered user with a second user,
identifying another user separate from the second user as an approver who has an authority to approve the request made to the second user;
transmitting an inquiry about approval of the request to a terminal device of the approver, and receiving an answer for the inquiry from the terminal device of the approver; and
determining whether or not to approve the request by the first user based on the received answer,
wherein if it is determined that the request by the first user is approved, the processor stores, in the storage section, identification information of the first user as a registered user with the second user.

2. The server system according to claim 1, wherein:
the processor further executes storing in the storage section, for at least one user, information of an approver who has an authority to approve a request made to the user, prior to the request; and
the processor identifies an approver based on the information of the approver stored in the storage section.

3. The server system according to claim 1, wherein:
the processor further executes transmitting an inquiry about approval of the request to a terminal device of the second user, and receiving an answer for the inquiry from the terminal device of the second user; and
the processor makes the determination based on the answer from the approver and the answer from the second user.

4. The server system according to claim 3, wherein:
if the answer received from the terminal device of the second user indicates approval of the request, the processor transmits the inquiry about approval of the request to the terminal device of the approver, whereas if the answer indicates disapproval of the request, the processor does not transmit the inquiry to the terminal device of the approver; and
the processor determines to approve the request by the first user if the answer from the second user and the answer from the approver both indicate approval of the request.

5. The server system according to claim 1, wherein the processor further executes, if the answer received from the terminal device of the approver indicates approval of the request, notifying the terminal device of the second user that the request has been made from the first user to the second user.

6. The server system according to claim 1, wherein the processor further executes, before transmitting the inquiry to the terminal device of the approver, notifying the terminal device of the second user that the request has been made from the first user to the second user.

7. The server system according to claim 1, wherein:
the processor further executes receiving, from the terminal device of the second user, information regarding whether or not to set the approver, and determining whether or not to set the approver based on the received information; and
the processor identifies the approver if it is determined that the approver is to be set.

8. The server system according to claim 1, wherein:
the processor further executes, if the request from the terminal device of the first user is received by the server system, transmitting an inquiry for selecting an approver for the request to the terminal device of the second user, and receiving information indicating a selected approver from the terminal device of the second user; and
the processor identifies the approver based on the received information indicating the approver.

9. The server system according to claim 1, wherein the processor executes:
if the request from the terminal device of the first user is received by the server system, identifying another user separate from the first user as a request allower who has an authority to allow the first user to make a request;
if the request from the terminal device of the first user is received, transmitting an inquiry about allowance of the request to a terminal of the request allower, and receiving an answer for the inquiry from the terminal device of the request allower; and
rendering the request by the first user valid if the answer received from the terminal device of the request allower indicates allowance of the request, and rendering the request by the first user invalid if the answer received from the terminal device of the request allower indicates non-allowance of the request,
wherein if the request is rendered valid, the processor transmits the inquiry about approval of the request to the terminal device of the approver.

10. The server system according to claim 1, wherein the processor transmits, to the terminal device of the approver, information including link information for accessing a webpage for giving an answer for the inquiry about approval of the request, and obtains the answer made on the webpage by the terminal device of the approver.

11. The server system according to claim 9, wherein the processor transmits, to the terminal device of the request allower, information including link information for accessing a webpage for giving an answer for the inquiry to the terminal device of the request allower, and obtains the answer made on the webpage by the terminal device of the request allower.

12. The server system according to claim 1, wherein if the inquiry about approval of the request is transmitted to the terminal device of the approver, the processor transmits, together with the inquiry, at least a part of profile information saved for the first user or link information for accessing the profile information.

13. The server system according to claim 1, wherein if an answer for the inquiry about approval of the request is not received within a predetermined period from the transmission of the inquiry, the processor considers it as being an answer for the inquiry indicating disapproval of the request by the first user.

14. The server system according to claim 1, wherein the predetermined authority over information regarding the second user is an authority to view information regarding the second user which cannot be viewed by another user who is not a registered user.

15. A server device saving information regarding a plurality of users and providing predetermined information regarding a certain user to another user,
wherein one or more processor of the server device executes:
storing in a storage section, for each user, identification information of another user registered as a registered user who is granted a predetermined authority over information regarding the user;
receiving, from a terminal device of a first user, a request for registering the first user as a registered user with a second user,
identifying another user separate from the second user as an approver who has an authority to approve the request made to the second user;
transmitting an inquiry about approval of the request to a terminal device of the approver, and receiving an answer for the inquiry from the terminal device of the approver; and
determining whether or not to approve the request by the first user based on the received answer,
wherein if it is determined that the request by the first user is approved, the processor stores, in the storage section, identification information of the first user as a registered user with the second user.

16. A non-transitory computer-readable storage medium storing an information processing program to be executed on a computer of a server system for saving information regarding a plurality of users and providing predetermined information regarding a certain user to another user,
wherein the information processing program causes the computer to execute:
storing in a storage section of the server system, for each user, identification information of another user registered as a registered user who is granted an authority to view information regarding the user;
receiving, from a terminal device of a first user, a request for registering the first user as a registered user with a second user;
identifying another user separate from the second user as an approver who has an authority to approve the request made to the second user;
transmitting an inquiry about approval of the request to a terminal device of the approver, and receiving an answer for the inquiry from the terminal device of the approver; and
determining whether or not to approve the request by the first user based on the received answer,
wherein if it is determined that the request by the first user is approved, the information processing program causes the computer to execute storing, in the storage section, identification information of the first user as a registered user with the second user.

17. A method to be carried out by a server system for saving information regarding a plurality of users and providing predetermined information regarding a certain user to another user,
wherein the server system stores in a storage section, for each user, identification information of another user registered as a registered user who is granted a predetermined authority over information regarding the user, the method comprising:
receiving, from a terminal device of a first user, a request for registering the first user as a registered user with a second user;
identifying another user separate from the second user as an approver who has an authority to approve the request made to the second user;
transmitting an inquiry about approval of the request to a terminal device of the approver, and receiving an answer for the inquiry from the terminal device of the approver;
determining whether or not to approve the request by the first user based on the received answer, and
if it is determined that the request by the first user is approved, storing, in the storage section, identification information of the first user as a registered user with the second user.
